(19) United States
(12) Patent Application Publication
(10) Pub. No.: US 2011/0164945 A1
(43) Pub. Date: Jul. 7, 2011

(54) BLIND RIVET AND A METHOD OF JOINING THEREWITH

(75) Inventors: Srinivasarao Lathabai, Victoria (AU); Vinay Kumar Tyagi, Victoria (AU); Gersende Marie Delphine Cantin, Victoria (AU); Dayalan Romesh Gunasegaram, Victoria (AU); Ian Curtis Thomas, Victoria (AU); Shane David Christian, South Australia (AU); David James Bell Ritchie, Victoria (AU); Trevor Neil Kearney, Victoria (AU)

(73) Assignee: Co-Operative Research Centre for Advanced Automotive Technology Ltd., Victoria (AU)

(21) Appl. No.: 12/992,538

(22) PCT Filed: May 11, 2009
(86) PCT No.: PCT/AU2009/000586

§ 371 Date: Feb. 9, 2011

(30) Foreign Application Priority Data
May 13, 2008 (AU) 2008902336

(51) Int. Cl. F16B 19/08

(52) U.S. Cl. 411/501

(57) ABSTRACT

The invention relates to blind rivets and to methods of joining therewith. The method of the invention is suitable for joining two or more workpieces with a blind rivet. The method includes the first step of positioning a blind rivet at a point of overlap of two or more workpieces, the blind rivet including a rivet body and a mandrel. The next step involves rotating the mandrel about a longitudinal axis thereof and contacting the mandrel with the overlapping workpieces, wherein the mandrel is rotated at a speed to cause plasticization of the overlapping workpieces. The method then involves causing the mandrel to penetrate through the plasticized overlapping workpieces and form an aperture therethrough. A further step of the method involves capturing a portion of the overlapping workpieces that is displaced upon the penetration of the mandrel and securing the rivet body within the aperture to join the overlapping workpieces. The invention also includes a workpiece penetrating and joining blind rivet. The blind rivet includes a rivet body including a shank having a first end, a second end and an axial passage extending through the shank between the first and second ends. Also included is a mandrel including a shaft positioned within the axial passage and a head at one end of the shaft for contacting a workpiece wherein the mandrel is configured so that when contacting the workpiece, being rotated about a longitudinal axis thereof at a speed to cause plasticization of the workpiece and being caused to penetrate through the plasticized workpiece the mandrel cores a portion of the plasticised workpiece, displaces the portion from the workpiece and forms an aperture in the workpiece.

### FIELD OF THE INVENTION

The invention relates to blind rivets and to methods of joining therewith.

### BACKGROUND OF THE INVENTION

Friction stir welding (FSW) is a process used to join metal workpieces, such as sheet metal, that typically uses a rotating tool in contact with a join line between the metal workpieces. The tool is traversed along the join line and friction generated by the tool results in heat that softens or plasticises the workpieces without necessarily reaching melting point thereof. As the tool is traversed along the join line between the workpieces, plasticised material intermingles and subsequently cools, hardening to form a bond between the two workpieces.

FSW techniques have been used in methods of joining workpieces with a rivet. Such methods are referred to as friction stir riveting (FSR) methods. In such methods, a rivet is rotated and contacted with overlapping portions of metal workpieces. Friction generated by the rotary motion of the rivet results in heat that softens or plasticises the workpieces and the rivet is forced through the plasticised overlapping workpieces to form a hole. The rivet is then fixed within the hole in a manner that joins the workpieces together.

Blind rivets have been used in joining methods involving FSR techniques without requiring access to both sides of the overlapping workpieces to be joined together. A problem that has been recognised with FSR techniques that employ blind rivets is that displaced material, or flash, caused as the rivet head penetrates and forms a hole through the workpiece is often pushed aside to a position surrounding the hole or it may become detached from the workpieces altogether. The presence of flash around the hole can affect the join between the workpieces, by preventing proper setting of the rivet, or if complete detachment occurs, the detached material may be loosely confined between or on one side of the joined workpieces and rattle when the workpieces are moved. In an alternative application, the workpieces might be sheet metal panels of a vehicle and any rattling can be annoying to the vehicle occupants.

Blind rivets having a mandrel with a solid head have been used in joining methods involving FSR techniques. Thus, a problem that has been recognised with FSR techniques that employ blind rivets is that although the forces required for the rivet to penetrate and form a hole through the workpiece are lower than if the workpiece is cold and hard, the forces required are still relatively high and may require an anvil to support the workpiece. If a one-sided riveting operation not involving an anvil is required, existing FSR techniques involving blind rivets may be unsuitable.

### SUMMARY OF THE INVENTION

In one aspect, the present invention provides a method of joining two or more workpieces with a blind rivet, the method including:
positioning a blind rivet at a point of overlap of two or more workpieces, the blind rivet including a rivet body and a mandrel;
rotating the mandrel about a longitudinal axis thereof and contacting the mandrel with the overlapping workpieces, wherein the mandrel is rotated at a speed to cause plasticization of the overlapping workpieces;
causing the mandrel to penetrate through the plasticized overlapping workpieces and form an aperture therethrough,
capturing a portion of the overlapping workpieces that is displaced upon the penetration of the mandrel; and
securing the rivet body within the aperture to join the overlapping workpieces.

The above form of the invention is advantageous in that by capturing a portion of the overlapping workpieces that is displaced upon the penetration of the mandrel, the displaced portion is prevented from being pushed aside to a position surrounding the hole or from becoming completely detached from the workpieces altogether. Thus, the above aspect may facilitate the proper setting of the rivet or may prevent rattling associated with detachment of the displaced portion from the workpieces altogether and the loose confinement of the displaced portion on one side of the workpieces. Furthermore, forms of the invention enable the position of the displaced portion to be controlled after penetration of the mandrel through the overlapping workpieces. Furthermore, the amount of flash formed as a result of the penetration of the mandrel through the overlapping workpieces is minimised.

In another form, capturing the portion of the overlapping workpieces that is displaced upon the penetration of the mandrel includes the mandrel capturing the portion of the overlapping workpieces.

Accordingly, to the extent that any flash is formed as a result of the penetration of the mandrel through the overlapping workpieces, most of it is captured by the mandrel.

In yet another form, capturing the portion of the overlapping workpieces that is displaced upon the penetration of the mandrel includes capturing the portion of the overlapping workpieces in an opening within the mandrel.

The method may include accommodating the portion of the workpiece that is displaced upon penetration of the mandrel through the workpiece within the opening in the mandrel which is open in the direction of penetration of the mandrel through the overlapping workpieces.

By remaining within the opening within the head of the mandrel, the displaced portion reinforces the head of the mandrel, which in turn reinforces the shank of the rivet body against forces applied by the overlapping workpieces in a radially inward direction and may provide additional resistance when a shear loading is applied to the joined workpieces. Accordingly, the capture of the displaced portion provides a stiffening effect that improves the effectiveness and durability of the rivet and the join between the overlapping workpieces

In another aspect, the present invention provides a method of joining two or more workpieces with a blind rivet, the method including:
positioning a blind rivet at a point of overlap of two or more workpieces, the blind rivet including a rivet body and a mandrel;
rotating the mandrel about a longitudinal axis thereof and contacting the mandrel with the overlapping workpieces, wherein the mandrel is rotated at a speed to cause plasticization of the overlapping workpieces;
causing the mandrel to penetrate through the plasticized overlapping workpieces and form an aperture therethrough, wherein the mandrel cores a portion of the overlapping workpieces that is displaced upon the penetration of the mandrel therethrough;
securing the rivet body within the aperture to join the overlapping workpieces.

An advantage of the joining method is that it eliminates the need to pre-prepare the overlapping workpieces with an aperture, by drilling or some other like means, through which the rivet may penetrate the overlapping workpieces. Instead, in the above process the rivet penetrates and forms the aperture through the overlapping workpieces itself.

The invention is advantageous in that if a force is applied to the mandrel to cause it to penetrate the overlapping workpieces the force may be significantly less than existing FSR techniques. This is because existing FSR techniques do not involve coring a portion of the overlapping workpieces upon penetration of the mandrel to form an aperture therethrough.

In one form, causing the mandrel to penetrate through the plasticized overlapping workpieces whereby the mandrel cores a portion of the overlapping workpieces that is displaced upon the penetration of the mandrel therethrough includes removing a substantially cylindrical portion of the overlapping workpieces.

In another form, the method further includes receiving the displaced portion of the overlapping workpieces within an opening in the mandrel which is open in the direction of penetration of the mandrel through the overlapping workpieces.

In yet another form, the method further includes capturing the displaced portion of the overlapping workpieces.

In one form, rotating the mandrel about a longitudinal axis thereof and contacting the mandrel with the overlapping workpieces includes rotating and contacting a surface positioned radially outwardly from the opening in the mandrel with the overlapping workpieces.

In another form, causing the mandrel to penetrate through the plasticized overlapping workpieces includes driving the mandrel through the plasticized overlapping workpieces.

In one form of the method the rivet body includes a shank having a first end, a second end and an axial passage extending through the shank between the first and second ends and an external surface facing radially outwardly from the axial passage with projections extending outwardly from the external surface for engaging the overlapping workpieces within the aperture thereof.

In another form, the mandrel includes a shaft with a head at one end, the shaft being positioned within the axial passage with the head at the second end of the shank, whereby securing the rivet body within the aperture to join the overlapping workpieces includes drawing the head into the axial passage whereby the shank expands radially outwardly within the aperture which causes the external projections to further engage the overlapping workpieces.

The projections are advantageous in that they positively engage the overlapping workpieces within the aperture to enhance the ability of the rivet to resist tensile shear loading and any resultant relative movement of the overlapping workpieces.

In one form, the rivet body includes a cap at the first end of the shank that extends radially outwardly from the shank, the cap including a workpiece engaging surface that faces towards and is oriented at various angles to the shank and securing the rivet body within the aperture to join the overlapping workpieces includes engaging the workpiece engaging surface with the overlapping workpieces.

In another form, the head has a longitudinal axis and a workpiece contacting surface positioned radially outwardly from the longitudinal axis of the head, wherein contacting the mandrel with the overlapping workpieces includes bringing the workpiece contacting surface into contact with the workpiece whereby the portion of the workpiece to be displaced and captured is positioned radially inwardly from the workpiece contacting surface.

In a form of the method, rotating the mandrel includes rotating the mandrel at from about 1000 to about 20000 revolutions per minute.

In another form of the method, causing the mandrel to penetrate through the plasticized overlapping workpieces includes driving the mandrel at a rate of from about 10 to about 1000 mm per minute.

In another form, the method further includes a dwell period wherein penetration of the mandrel through the overlapping workpieces is temporarily suspended when the mandrel has penetrated to a predetermined depth through the overlapping workpieces while the mandrel continues to rotate.

The above form of the invention is advantageous in that it provides at least one dwell period during the penetration of the mandrel through the workpieces to enable additional frictional heating that reduces a force required to enable the mandrel to penetrate through the workpiece.

In another aspect, the invention provides a workpiece penetrating blind rivet, the blind rivet including:

a rivet body including a shank having a first end, a second end and an axial passage extending through the shank between the first and second ends;
a mandrel including a shaft positioned within the axial passage and a head at one end of the shaft for contacting a workpiece,
wherein the mandrel is configured so that when contacting the workpiece, being rotated about a longitudinal axis thereof at a speed to cause plasticization of the workpiece and being caused to penetrate through the plasticized workpiece, the mandrel cores a portion of the plasticised workpiece, displaces the portion from the workpiece and forms an aperture in the workpiece.

In one form, the head of the mandrel includes a workpiece contacting surface positioned radially outwardly from the longitudinal axis of the mandrel and an opening positioned radially inwardly from the workpiece contacting surface wherein the workpiece contacting surface cores the portion of the workpiece and the opening is open in the direction of penetration of the mandrel through the workpiece for receiving the portion of the workpiece.

In yet another form, the opening is configured to capture the portion of the workpiece that is displaced upon penetration of the mandrel therethrough.

In one form, the opening is substantially cylindrical.

In another form, the opening has a proximal end and a distal end and the opening has a diameter that decreases in a direction from the proximal end to the distal end.

In yet another form, the opening has a proximal end and a distal end and the opening has a diameter that increases in a direction from the proximal end to the distal end.

In one form, the opening may be defined by a wall within the head of the mandrel and one or more projections may extend from the wall and into the opening for positively engaging the captured portion of the workpiece.

In another form, a projection extends from an outer surface of the head of the mandrel away from the opening. The projection extending from an outer surface of the head of the mandrel may be a helical thread.

In yet another form, the opening may be defined by a wall within the head of the mandrel or the wall may include a groove for positively engaging the captured portion of the workpiece.

In still yet another form, the opening may be defined by a wall within the head of the mandrel and a thread may extend from the wall and into the opening for positively engaging the captured portion of the workpiece.

In another form, the opening may be defined by a wall within the head of the mandrel and a hole may extend through the wall transversely from the opening for positively engaging the captured portion of the workpiece.

In another form, the shank has an external surface facing radially outwardly from the axial passage and the external surface includes an external projection for engaging the workpiece within the aperture thereof. The external projection on the external surface of the shank may be a helical thread.

The rivet body may include a cap at the first end of the shank that extends radially outwardly from the shank. The cap may also include a workpiece engaging surface that faces towards and is oriented at various angles to the shank.

In one form, the mandrel includes an annular surface for initial contact with the workpiece that lies in a plane oriented transversely to the longitudinal axis of the mandrel.

In another form, the mandrel includes an annular surface for initial contact with the workpiece that faces towards and is oriented at an acute angle to the longitudinal axis of the mandrel.

In yet another form, the mandrel includes an annular surface for initial contact with the workpiece that faces from and is oriented at an obtuse angle to the longitudinal axis of the mandrel.

In another form, the mandrel includes an annular surface for initial contact with the workpiece and teeth projecting from the annular surface.

In still yet another form, the mandrel includes first and second annular surfaces for initial contact with the workpiece, the first annular surface faces towards and is oriented at an acute angle to the longitudinal axis of the head and the second annular surface faces from and is oriented at an obtuse angle to the longitudinal axis of the head and the first and second annular surfaces meet at an apex.

In another aspect, the invention provides at least two joined overlapping workpieces that are joined together with a blind rivet:
the blind rivet including a mandrel and a rivet body;
the workpieces including an aperture that has been formed therethrough by contact between the mandrel and the workpieces, rotation of the mandrel about a longitudinal axis thereof at a speed to cause plasticization of the workpieces and penetration of the mandrel through the plasticized workpieces whereby the mandrel cores a portion of the plasticised workpieces and displaces the portion from the workpieces;
the rivet body including a shank having a first end, a second end and an axial passage extending through the shank between the first and second ends, the rivet body being positioned within the aperture and the mandrel being positioned within the axial passage whereby the shank is expanded radially outwardly and into engagement with the workpieces for joining the overlapping workpieces.

In one form, the mandrel has captured the displaced portion of the overlapping workpieces.

In one form, the mandrel includes an opening which is open in the direction of penetration of the mandrel through the overlapping workpieces and which accommodates the displaced portion of the overlapping workpieces.

### BRIEF DESCRIPTION OF THE DRAWINGS

It will be convenient to hereinafter describe the invention in detail with reference to the attached drawings that illustrate preferred embodiments of a blind rivet, a mandrel for a blind rivet and methods of joining overlapping workpieces in accordance with the invention. It should be appreciated, however, that the generality of the preceding portion of the specification is not to be superseded by the specifics of the following description.

FIG. 1 illustrates a side cross-section view of a rivet in accordance with a form of the invention, the rivet including a rivet body and a mandrel. The rivet body includes a shank with an axial passage therethrough and a cap at one end of the shank. The mandrel has an elongated shaft and a head at one end of the shaft and is positioned within the axial passage extending through the shank of the rivet body. The head of the mandrel includes an opening arranged to capture a portion of a workpiece that is displaced as a result of the head of the mandrel penetrating the workpiece.

FIG. 2 illustrates a perspective view of the rivet of FIG. 1.

FIGS. 3A to 3H illustrate a joining method in accordance with a form of the invention.

FIG. 4 illustrates a side cross-section view of a rivet in accordance with another form of the invention in which a workpiece contacting surface of the head of the mandrel faces towards and is orientated at an acute angle relative to a longitudinal axis of the head.

FIG. 5 illustrates a side cross-section view of a rivet in accordance with another form of the invention in which a wall defining the opening within the head of the mandrel has a groove for positively engaging the displaced portion of the workpiece captured within the opening.

FIG. 6 illustrates a side cross-section view of a rivet in accordance with another form of the invention in which the wall defining the opening within the head of the mandrel includes an annular projection extending into the opening for positively engaging the displaced portion of the workpiece captured within the opening.

FIG. 7 illustrates a side cross-section view of a rivet in accordance with another form of the invention in which a transverse hole extends through the wall defining the opening within the head of the mandrel for positively engaging the displaced portion of the workpiece captured within the opening.

FIG. 8 illustrates a side cross section view of a rivet in accordance with another form of the invention in which the wall defining the opening within the head of the mandrel includes an internal thread for positively engaging the displaced portion of the workpiece captured within the opening.

FIG. 9 illustrates a side cross-section view of a rivet in accordance with another form of the invention in which the opening has a proximal portion and a distal portion and wherein the diameter of the opening decreases in a direction from the proximal portion to the distal portion.

FIG. 10 illustrates a side cross-section view of a rivet in accordance with another form of the invention in which the diameter of the opening increases in a direction from the proximal portion to the distal portion.

FIG. 11 illustrates a side cross-section view of a rivet in accordance with another form of the invention in which the workpiece contacting surface includes first and second sub-surfaces that are respectively oriented towards and away from the longitudinal axis of the head and that meet at an apex.

FIG. 12 illustrates a side cross-section view of a rivet in accordance with another form of the invention in which the workpiece contacting surface faces from and is oriented at an obtuse angle relative to the longitudinal axis of the head.

FIG. 13 illustrates a cross-section view of a rivet in accordance with another form of the invention in which the internal surface of the wall defining the opening within the head of the mandrel includes an internal annular projection and the opposite external surface of the wall includes an external annular projection.

FIG. 14 illustrates a side cross-section view of a rivet in accordance with another form of the invention in which an external surface of the shank of the rivet body includes an external thread for positively engaging the workpiece after penetration therethrough.

FIG. 15 illustrates a side cross-section view of a rivet in accordance with another form of the invention in which a workpiece contacting surface of the cap has portions that face towards the shank at various angles relative to the shank.

FIG. 16 illustrates in more detail the step of the joining method illustrated in FIG. 3B.

FIG. 17 illustrates in more detail the step of the joining method illustrated in FIG. 3H.

FIG. 18 illustrates a side view of a mandrel of a rivet in accordance with another form of the invention in which the initial workpiece contacting surface includes a set of teeth having a relatively blunt profile.

FIG. 19 illustrates a side view of a mandrel of a rivet in accordance with another form of the invention in which the initial workpiece contacting surface includes a set of teeth having a relatively sharp profile.

FIG. 20 illustrates a bottom view of a mandrel of a rivet in accordance with another form of the invention which the internal surface of the wall defining the opening within the head of the mandrel includes a plurality of internal annular projections.

FIG. 21 illustrates a side cross-section view of a rivet in accordance with another form of the invention in which the mandrel and the rivet body each include external projections in the form of a helical thread.

### DETAILED DESCRIPTION

### A Blind Rivet

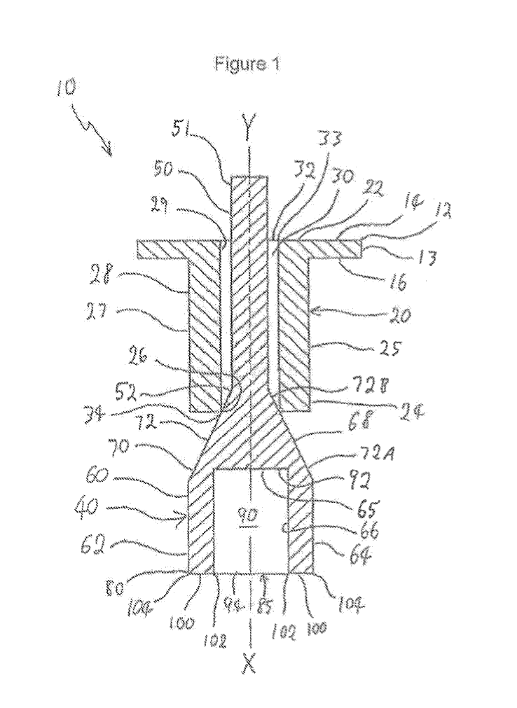

FIGS. 1 to 15 illustrate a blind rivet 10 and a method of joining overlapping portions of an upper workpiece 112 and a lower workpiece 114. The rivet 10 includes a rivet body 20 and a mandrel 40. The rivet body 20 includes a shank 25 having a first end 22, a second end 24 and an axial passage 30 extending between the first end 22 and the second end 24. The mandrel 40 includes a longitudinal axis X, a stem 50 and a head 60 connected to the stem 50. The stem 50 is positioned within the axial passage 30 within the rivet body 20 with the head 60 positioned adjacent to the second end 24 thereof. The head 60 includes a proximal end 70, a distal end 80, an entrance 85 at the distal end 80 and an opening 90 extending from the entrance 85 at the distal end 80 towards the proximal end 70 of the head 60.

The head 60 further includes an initial workpiece contacting surface 100 at the distal end 80 that surrounds the entrance 85 at the distal end 80 of the head 60. In the embodiments illustrated in the Figures, the initial workpiece contacting surface 100 is annular. However, it is to be appreciated that the initial workpiece contacting surface 100 may have other suitable profiles with curved or planar edges. The initial workpiece contacting surface 100 is configured to initially contact with either one of the overlapping upper workpiece 112 and lower workpiece 114 and be rotated at a speed to cause, or at least contribute to, plasticization of the overlapping upper workpiece 112 and lower workpiece 114 to enable the head 60 to penetrate therethrough. Plasticisation of the overlapping upper workpiece 112 and lower workpiece 114 at least partially results from frictional heat generated between the rotating initial workpiece contacting surface 100 and the material of the overlapping workpieces 112, 114. This heat causes the overlapping workpieces 112, 114 to soften without necessarily reaching their melting point. Accordingly, plasticisation of the overlapping workpieces 112, 114 is the softening of the overlapping workpieces 112, 114 without necessarily reaching their melting point.

When the material forming the upper workpiece 112 and the material forming the lower workpiece 114 plasticise and soften a force may be applied to the mandrel 40 to cause the head 60 of the mandrel 40 to penetrate through the upper workpiece 112 and the lower workpiece 114. The force required for the head 60 of the mandrel 40 to penetrate through the plasticised and softened upper and lower workpieces 112, 114 is substantially less than when the upper and lower workpieces 112, 114 are in a cooled and hardened state. By causing the mandrel 40 to penetrate through the plasticized overlapping workpieces 112, 114 the mandrel 40 thereby displaces a portion 120 of the overlapping workpieces 112, 114 to form an aperture therethrough. In forms of the invention, the penetration of the head 60 through the overlapping upper and lower workpieces 112, 114 may result in the head 60 of the mandrel 40 coring the displaced portion 120 of the overlapping upper and lower workpieces 112, 114 therefrom. In other forms of the invention, the penetration of the head 60 through the overlapping upper and lower workpieces 112, 114 may result in the displaced portion 120 being received and/or captured by the head 60 of the mandrel 40.

Referring to FIGS. 1 to 15, the shank 25 of the rivet body 20 includes a cylindrically shaped side wall 27 which may be made out of any suitably rigid material. The side wall 27 includes an outwardly facing external surface 28 and an opposite internal surface 29 extending from the first end 22 to the second end 24 of the shank 25. Where the side wall 27 is cylindrical in shape the external surface 28 and the internal surface 29 are also cylindrically shaped surfaces. Although the embodiments described and illustrated herein include a cylindrically shaped side wall 27, it is to be appreciated that the side wall 27 may have any suitable shape or configuration. For example, the side wall 27 may have a square, hexagonal, octagonal or any other suitably shaped profile. Similarly, the external surface 28 and the internal surface 29 of the side wall 27 may have a square, hexagonal, octagonal or any other suitably shaped profile.

The internal surface 29 defines the axial passage 30 extending through the shank 25. The axial passage 30 is coaxial with a longitudinal axis Y of the rivet body 20. The axial passage 30 extends from a first entrance 32 at the first end 22 of the shank 25 to a second entrance 34 at the second end 24 of the shank 25. The axial passage 30 may have a constant diameter and/or profile throughout or it may have variations in diameter and/or profile throughout from the first entrance 32 to the second entrance 34.

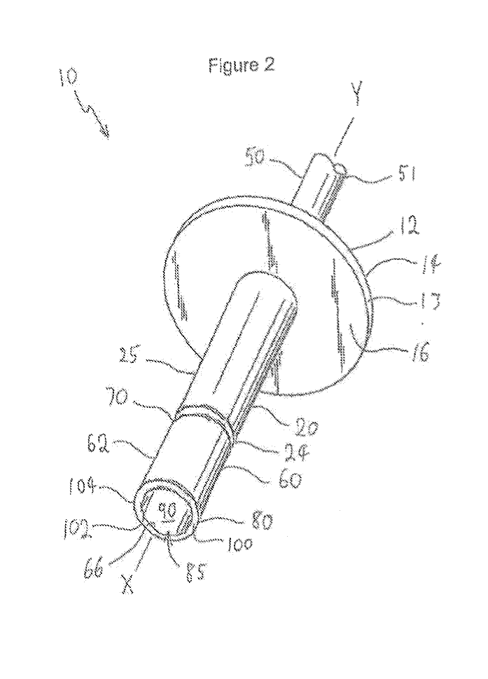

The rivet body 20 includes a cap 12 connected to the first end 22 of the shank 25. The cap 12 includes a top surface 14 and an opposite workpiece engaging surface 16. The top surface 14 and the workpiece engaging surface 16 are both flanges that extend from the shank 25 of the rivet body 20 and in directions that are substantially parallel to each other and transverse to the longitudinal axis Y of the rivet body 20. The top surface 14 extends from a peripheral edge 33 of the first entrance 32 in a radially outward direction from the longitudinal axis Y of the rivet body 20. The workpiece engaging surface 16 extends from the external surface 28 of the shank 25 in a radially outward direction from the longitudinal axis Y of the rivet body 20. An outer perimeter surface 13 defines a radially outer perimeter of the cap 12 and extends between the top surface 14 and the workpiece engaging surface 16. Referring to FIG. 2, the cap 12 may be configured in the form of a disk having a top surface 14 and a workpiece engaging surface 16 that are both substantially planar.

The cylindrical side wall 27 of the shank 25 extends in the direction of the longitudinal axis Y of the rivet body from the workpiece engaging surface 16 of the cap 12 to a mandrel engaging surface 26. The mandrel engaging surface 26 is an annular surface extending between the external surface 28 and the internal surface 29 of the side wall 27. The mandrel engaging surface 26 faces in a direction toward the head 60 of the mandrel 40.

In the embodiments illustrated in FIGS. 1 to 15, the mandrel 40 has a head 60 which has a substantially cylindrical profile. However, it is to be appreciated that the head 60 of the mandrel 40 may have any suitable shape or configuration. For example, the head 60 may have a square, hexagonal, octagonal or any other suitably shaped profile. The proximal end 70 of the head 60 is connected to a distal end 52 of the stem 50. The stem 50 extends from the distal end 52 in substantially the same direction as the longitudinal axis X of the mandrel 40 to a proximal end 51 of the stem 50. When the stem 50 of the mandrel 40 is positioned within the axial passage 30 within the rivet body 20 the longitudinal axis X of the mandrel 40 is substantially coaxial with longitudinal axis Y of the rivet body 20. The stem 50 has a longitudinal length that is greater than a length of the axial passage 30 of the shank 25 so that the proximal end 51 of the stem 50 protrudes from the first entrance 32 at the first end 22 of the shank 25 and the distal end 52 of the stem 50 protrudes from the second entrance 34 at the second end 24 of the shank 25. The protruding distal end 52 of the stem 50 is connected to the proximal end 70 of the head 60.

The head 60 of the mandrel 40 includes a side wall 62 which, in the embodiments illustrated in the Figures, is substantially cylindrical in shape and surrounds the longitudinal axis X of the mandrel 40. The side wall 62 has an external surface 64 and an opposite internal surface 66 which both extend substantially parallel and in substantially the same direction as the longitudinal axis X of the mandrel 40. In the embodiments where the side wall 62 is cylindrical the external surface 64 and the internal surface 66 are also substantially cylindrical in shape.

The proximal end 70 of the head 60 has a base 68 and the side wall 62 extends from the base 68 to the initial workpiece contacting surface 100 at the distal end 80 of the head 60. In the embodiments illustrated in the Figures, the initial workpiece contacting surface 100 is annular and extends between a radially outer edge 104, where the initial workpiece contacting surface 100 meets the external surface 64 of the side wall 62, and a radially inner edge 102, where the initial workpiece contacting surface 100 meets the internal surface 66. The opening 90 within the head 60 is defined within the internal surface 66 of the side wall 62. The opening 90 extends substantially in the direction of the longitudinal axis X of the mandrel 40. Accordingly, the opening 90 is substantially coaxial with the longitudinal axis X of the mandrel 40. The opening 90 includes a proximal end 92 at the proximal end 70 of the head 60 and a distal end 94 at the distal end 80 of the head 60.

The entrance 85 for the opening 90 in the head 60 is located at the distal end 94 of the opening 90. The entrance 85 is surrounded radially outwardly by the initial workpiece contacting surface 100 and the inner edge 102 thereof. Accordingly, the annular initial workpiece contacting surface 100 extends around and defines a perimeter of the opening 90 within the head 60. In forms in which the initial workpiece contacting surface 100 is not annular the initial workpiece contacting surface 100 may still extend around and defines a perimeter of the opening 90 within the head 60. The entrance 85 to the opening 90 in the head 60 of the mandrel 40 is defined radially within the inner edge 102 of the initial workpiece contacting surface 100. At the proximal end 92 of the opening 90 an end surface 65 caps the internal surface 66 of the side wall 62. Accordingly, the entrance 85 and the end surface 65 are at opposite ends of the opening 90. In the embodiments illustrated in the Figures the end surface 65 is a circular shaped surface that is either planar or concave, however, the end surface 65 may have any type of smooth or irregular finish.

The stem 50 is connected to the head 60 of the mandrel by way of a connection between the distal end 52 of the stem 50 and the base 68 of the head 60. The connection between the distal end 52 of the stem 50 and the base 68 may take any suitable form. In the forms illustrated in the Figures, the distal end 52 of the stem 50 is integrally formed with the base 68 in a substantially longitudinal location. The proximal end 70 of the head 60 has a rivet body engaging surface 72 which faces towards the mandrel engaging surface 26 of the rivet body 20. Thus, the rivet body engaging surface 72 and the mandrel engaging surface 26 are oriented so that they substantially oppose each other.

In the forms illustrated in the Figures the rivet body engaging surface 72 of the mandrel 40 is an external surface of an enlarged portion of the stem 50 at the distal end 52 thereof. The rivet body engaging surface 72 illustrated in the Figures is substantially frustoconical in shape. The frustoconical rivet body engaging surface 72 includes a radially wider portion 72A and a radially narrower portion 72B. The frustoconical rivet body engaging surface 72 extends along at least a portion of the stem 50 from the radially wider portion 72A at the distal end 52 of the stem 50 to the radially narrower portion 72B in a direction towards the proximal end 51 of the stem 50. The stem 50 is radially narrower than the external surface 64 of the head 60 and the rivet body engaging surface 72 tapers from the radially narrower stem 50 to the radially wider external surface 64 of the head 60.

### Joining Method

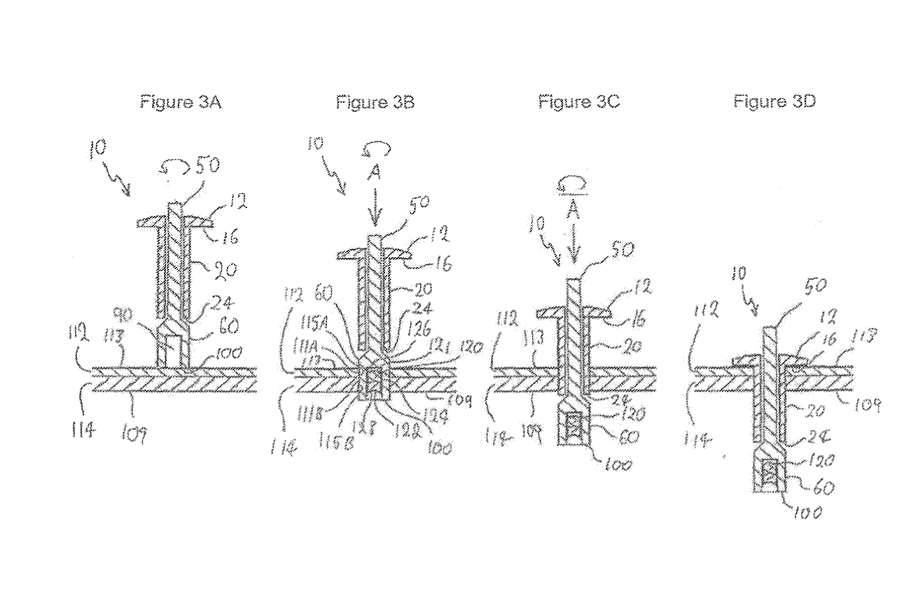

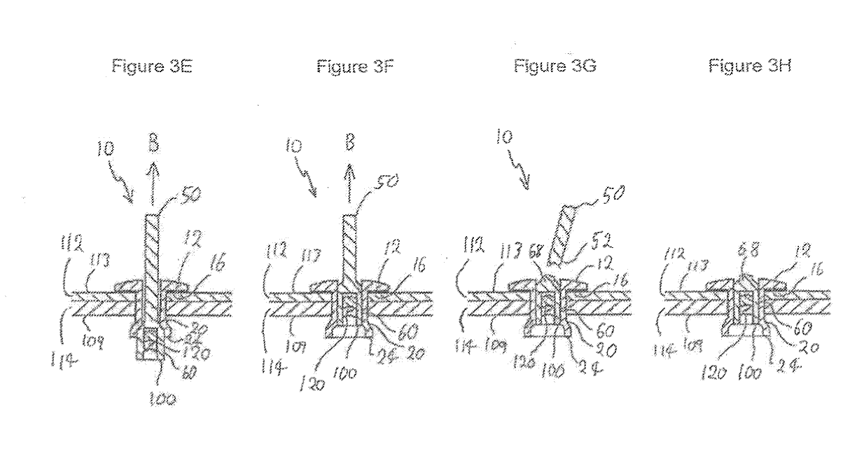

Referring to FIGS. 3A to 3H, a method of joining an upper workpiece 112 to a lower workpiece 114 using a blind rivet 10, in accordance with a form of the invention, is illustrated. In FIG. 3A, the rivet 10 is positioned such that the initial workpiece contacting surface 100 of the head 60 of the mandrel 40 comes into contact with an upper surface 113 of the upper workpiece 112 at a point where the upper workpiece 112 and the lower workpiece 114 overlap. As mentioned above, the annular initial workpiece contacting surface 100 extends around and defines a perimeter around the opening 90 within the head 60. Accordingly, the annular initial workpiece contacting surface 100 contacts an annular portion of the upper surface 113 of the upper workpiece 112. The elongated stem 50 of the mandrel 40 is engaged by a tool (not shown) for rotating the mandrel 40. The tool for rotating the mandrel may take any suitable form. When activated, the tool for rotating the mandrel causes the mandrel 40 to rotate. Preferably, the mandrel 40 is rotating when the initial workpiece contacting surface 100 is brought into contact with the upper surface 113 of the upper workpiece 112. Frictional heat is generated as a result of the rotation of the initial workpiece contacting surface 100 when in contact with the upper surface 113 of the upper workpiece 112. The rate or speed of rotation of the initial workpiece contacting surface 100 that is generated by the tool for rotating the mandrel is sufficient so that the frictional heat that is generated causes at least some plasticisation and softening of the material forming the upper workpiece 112 and/or the lower workpiece 114.

The speed of rotation of the mandrel 40 required to cause at least some plasticisation and softening of the upper and lower workpieces 112, 114 depends on the nature of the material forming the workpieces 112, 114. Where the material forming the upper and lower workpieces 112, 114 is an aluminium alloy the speed of rotation of the mandrel 40 may be from about 1000 to about 20,000 revolutions per minute. Where the material forming the upper and lower workpieces 112, 114 is an alloy such as steel, a magnesium alloy, or combinations of alloys, the speed of rotation required to cause plasticisation and softening of the upper and lower workpieces 112, 114 may be also from about 1000 to about 20,000 revolutions per minute. The material forming the upper and lower workpieces 112, 114 may be any rigid material which may include non-metallic materials, such as polymer and composite materials. An appropriate speed of rotation required to cause plasticisation of the rigid material forming the upper and lower workpieces 112, 114 may be employed. The actual speed of rotation that is selected may depend on the physical properties of the materials forming the upper and lower workpieces 112, 114, such as their tensile properties, their thickness and the number of layers of the upper and lower workpieces 112, 114 to be joined.

The heat that is generated as a result of the friction between the initial workpiece contacting surface 100 and the upper surface 113 of the upper workpiece 112 results in the material of the upper workpiece 112 immediately below and including the upper surface 113 to plasticise and soften. As will be explained below in more detail, a force is applied to the mandrel 40 in the direction indicated by the arrow A in FIG. 3B to cause the mandrel to penetrate through the plasticised and softened material immediately below and including the upper surface 113 of the upper workpiece 112 such that the mandrel 40 progressively penetrates through the upper workpiece 112. As the mandrel 40 progressively penetrates through the upper workpiece 112 the material forming the upper workpiece 112 immediately before the mandrel 40 plasticises and softens to facilitate to the penetration of the mandrel 40 therethrough. Once having penetrated through the upper workpiece 112, the mandrel 40 then meets the lower workpiece 114. The mandrel 40 progressively plasticises and penetrates through the material of the lower workpiece 114 immediately before the mandrel 40 until the mandrel has penetrated the lower workpiece 114 completely as illustrated in FIG. 3B.

Referring to FIG. 3B, the material forming the upper workpiece 112 and the material forming the lower workpiece 114 have plasticised and softened and the mandrel 40 has been driven by the force indicated by the arrow A at a predetermined speed in the direction of penetration of the mandrel 40 through the upper and lower workpieces 112, 114. The force applied to the mandrel 40 in the direction indicated by the arrow A may be applied to the mandrel 40 via any suitable means such as via the means for rotating the mandrel 40. The predetermined speed at which the mandrel 40 is driven in the direction of penetration through the upper and lower workpieces 112, 114 indicated by the arrow A can be anything from about 10 to about 1000 mm per minute.

As can be seen in FIG. 3B, the result of driving the mandrel 40 in the direction of penetration through the upper and lower workpieces 112, 114 is that the initial workpiece contacting surface 100 as well as the side wall 62 of the head 60 penetrate through the plasticised and softened upper and lower workpieces 112, 114 and the initial workpiece contacting surface 100 exits through a lower surface 109 of the lower workpiece 114. As a result of the penetration of the head 60 through the upper workpiece 112 and the lower workpiece 114, a first aperture 111A is formed through the upper workpiece 112 and a second aperture 111B is formed through the lower workpiece 114. The apertures 111A, 111B are respectively defined by first and second lateral surfaces 115A, 115B respectively surrounding the apertures and extending through the overlapping upper and lower workpieces 112, 114 from the upper surface 113 to the lower surface 109. Typically, the lateral surface 115 will have a circular profile and will be substantially cylindrical, frustoconical or the like.

As mentioned above, the annular initial workpiece contacting surface 100 extends around and defines a perimeter around the opening 90 within the head 60. Accordingly, the annular initial workpiece contacting surface 100 contacts an annular portion of the upper surface 113 of the upper workpiece 112. When the mandrel 40 is driven in the direction of penetration through the upper and lower workpieces 112, 114 the initial workpiece contacting surface 100 penetrates through the plasticised upper workpiece 112 in a coring action wherein an annular ring of material of the upper workpiece 112 is displaced from the upper workpiece 112 and a substantially circular core portion of the upper workpiece 112, referred to herein as the upper displaced portion 121, is thereby removed from the upper workpiece 112. Similarly, the initial workpiece contacting surface 100 penetrates through the plasticised lower workpiece 114 in a coring action wherein an annular ring of material of the lower workpiece 114 is displaced from the lower workpiece 114 and a substantially circular core portion of the lower workpiece 112, referred to herein as the lower displaced portion 122, is thereby removed from the lower workpiece 112. The annular rings of material that are displaced from the upper and lower workpieces 112, 114 may be displaced at least partially by the rotation of the initial workpiece contacting surface 100 relative to the upper and lower workpieces 112, 114. In this way, the initial workpiece contacting surface 100 may contribute to cutting and/or shearing the annular rings of material from the upper and lower workpieces 112, 114 whereby the substantially circular upper and lower displaced portions 121, 122 are thereby removed from the upper and lower workpieces 112, 114 to form the first and second apertures 111A, 111B therethrough. By coring the upper and lower displaced portions 121, 122 of the displaced portion 120 from the overlapping upper and lower workpieces 112, 114 when the upper and lower workpieces 112, 114 are plasticized and softened in the manner described above, the mandrel 40 may only require a relatively small amount of force applied to it in the direction of penetration through the overlapping upper and lower workpieces 112, 114 indicated by the arrow A to penetrate therethrough.

As the head 60 of the mandrel 40 begins to penetrate through the upper workpiece 112 and begins to form the first aperture 111A through the upper workpiece 112 not only does the initial workpiece contacting surface 100 contact the upper workpiece 112 but so too does the internal surface 66 and the external surface 64 of the side wall 62 begin to contact the upper workpiece 112. The internal surface 66 begins to contact the portion of the upper workpiece 112 that ultimately forms part of the displaced portion 120 and the external surface 64 begins to contact the first lateral surface 115A defining the first aperture 111A formed as a result of the penetration of the head 60 of the mandrel 40 through the upper workpiece 112. The contact between the internal surface 66 and the external surface 64 of the side wall 62 of the head 60 of the mandrel 40 with the upper workpiece 112 results in the generation of additional frictional heat therebetween when the mandrel 40 is rotated. The additional heat enhances the plasticisation of the overlapping upper workpiece 112 and lower workpiece 114 so that the head 60 of the mandrel 40 may penetrate therethrough. Accordingly, the initial workpiece contacting surface 100 as well as the internal and external surfaces 66, 64 constitute a workpiece contacting surface of the mandrel 40 that contact the upper and lower workpieces 112, 114 and cause plasticisation thereof when the mandrel 40 is rotated at a sufficient speed.

As mentioned above, when the initial workpiece contacting surface 100 penetrates through the plasticised upper workpiece 112 and the plasticised lower workpiece 114, the initial workpiece contacting surface 100 applies a cutting and/or a shearing action to the plasticised upper workpiece 112 and the plasticised lower workpiece 114. As a result of the cutting and/or shearing action applied by the mandrel 40 to the plasticised upper workpiece 112 and the plasticised lower workpiece 114, the displaced portion 120 is cored by the mandrel from the upper workpiece 112 and the lower workpiece 114. The inner edge 102 of the initial workpiece contacting surface 100 defining the entrance 85 to the opening 90 of the head 60 defines the diameter of the displaced portion 120 that is displaced by the mandrel 40 from the plasticised upper and lower workpieces 112, 114. Accordingly, the inner edge 102 defines the diameter of the displaced portion 120 that is cored by the mandrel from the plasticised upper and lower workpieces 112, 114. Furthermore, the diameter of the apertures 111A, 111B formed by the penetration of the mandrel 40 the plasticised upper and lower workpieces 112, 114 is defined by the outer-most diameter of the external surface 64 of the side wall 62 of the mandrel 40.

The displaced portion 120 of the overlapping workpieces 112, 114 that is displaced upon penetration of the head 60 therethrough is, prior to penetration of the head 60 through the overlapping workpieces 112, 114, positioned radially inwardly from the initial workpiece contacting surface 100 of the head 60. The displaced portion 120 includes the upper displaced portion 121 which is made up of material from the upper workpiece 112 and the lower displaced portion 122 which is made up of material from the lower workpiece 114. The forms of the invention described above are advantageous in that by plasticising and softening the material forming the upper and lower workpieces 112, 114 and coring the displaced portion 120, including the upper displaced portion 121 and the lower displaced portion 122, from the upper and lower workpieces 112, 114 the force that is required to be exerted on the mandrel 40 to penetrate the upper and lower workpieces 112, 114 is significantly less than with existing FSR techniques or if the material forming the upper workpiece 112 and lower workpiece 114 is cool and hard.

The head 60 of the mandrel 40 penetrates firstly through the upper workpiece 112 to core the upper displaced portion 121 from the upper workpiece 112 and form the first aperture 111A therethrough. However, at this stage the lower workpiece 114 remains intact and abuts against the upper displaced portion 121 to force the upper displaced portion 121 through the entrance 85 and into the opening 90 within the head 60 of the mandrel 40 as the mandrel 40 is forced to penetrate through the upper workpiece 112. After penetrating through the upper workpiece 112 the head 60 of the mandrel 40 then begins to penetrate through the lower workpiece 114. The lower surface 109 of the lower workpiece 114 remains intact as the head 60 of the mandrel 40 partially penetrates through the lower workpiece 114. Thus, the intact lower surface 109 of the lower workpiece 114 holds the lower displaced portion 122 stationary relative to the head 60 of the mandrel 40 so that the lower displaced portion 122 begins to pass through the entrance 85 and into the opening 90 within the head 60 of the mandrel 40. The head 60 of the mandrel 40 then penetrates completely through the lower workpiece 114 to core the lower displaced portion 122 from the lower workpiece 114 and thereby form the second aperture 111B therethrough. As the head 60 of the mandrel 40 penetrates completely through the lower workpiece 114, the lower displaced portion 122 is completely cored from the lower workpiece 114 and at least partially passes through the entrance 85 and into the opening 90 within the head 60 of the mandrel 40. Thus, the upper displaced portion 121 and the lower displaced portion 122 at least partially pass through the entrance 85 and into the opening 90 within the head 60 of the mandrel 40 to be received therewithin. The opening 90 within the head 60 provides a space for accommodating the received upper and lower displaced portions 121, 122.

The displaced portion 120, which includes the upper displaced portion 121 and the lower displaced portion 122, passes through the entrance 85 and is received in the opening 90 within the head 60 of the mandrel 40. The displaced portion 120 has a top surface 126, a bottom surface 128 and a lateral surface 124 extending between the top surface 126 and the bottom surface 128. The top surface 126 formed part of the upper surface 113 of the upper workpiece 112 prior to displacement of the upper displaced portion 121 from the upper workpiece 112. The bottom surface 128 formed part of the lower surface 109 of the lower workpiece 114 prior to displacement of the lower displaced portion 122 from the lower workpiece 114. The lateral surface 124 substantially conforms to the shape and size of the internal surface 66 of the side wall 62 within the head 60 of the mandrel 40.

The magnitude of the force that is required to be applied to the mandrel 40 in the direction of penetration of the mandrel 40 through the overlapping upper and lower workpieces 112, 114 indicated by the arrow A in FIGS. 3A and 3B is also dependant on the speeds at which the mandrel 40 is rotated and driven in the direction of penetration through the upper and lower workpieces 112, 114. For example, an increase in the speed of rotation of the mandrel 40 will result in the overlapping upper and lower workpieces 112, 114 being increasingly plasticised and softened and therefore the amount of force required to be applied to the mandrel 40 to penetrate the overlapping upper and lower workpieces 112, 114 is reduced.

Alternatively, an increase in the speed at which the mandrel 40 is driven in the direction of penetration through the upper and lower workpieces 112, 114 will result in a greater magnitude of force to be applied to mandrel 40 to penetrate the overlapping upper and lower workpieces 112, 114. Thus, by varying the speed of rotation of the mandrel 40 and the speed at which the mandrel 40 is driven in the direction of penetration through the upper and lower workpieces 112, 114 the magnitude of the force required to be applied to the mandrel 40 to penetrate the overlapping upper and lower workpieces 112, 114 can be adjusted.

Thus, for a given speed of rotation of the mandrel 40 driving the mandrel 40 at a relatively slower speed in the direction of penetration through the upper and lower work pieces 112, 114 requires a lower peak magnitude of force to be applied to the mandrel 40 to cause the mandrel 40 to penetrate the overlapping upper and lower workpieces 112, 114. However, for a given speed of rotation of the mandrel 40 driving the mandrel 40 at a relatively slower speed in the direction of penetration through the upper and lower work pieces 112, 114 also means that the time taken for the mandrel 40 to penetrate the upper and lower workpieces 112, 114 is relatively higher. This results in the overall time required to complete the joining method being relatively long.

Reducing the duration of the joining method can be achieved by driving the mandrel 40 in the direction of penetration through the upper and lower workpieces 112, 114 at different speeds throughout the process of driving the mandrel 40 through the upper and lower workpieces 112, 114. For example, the mandrel 40 can initially be driven in the direction of penetration through the upper and lower workpieces 112, 114 at a first speed, which is a relatively slower speed, as the mandrel 40 initially contacts the upper surface 113 of the upper work piece 112 until the mandrel 40 penetrates through a portion of the thickness of the upper and lower workpieces 112, 114. The speed at which the mandrel 40 is driven in the direction of penetration is then increased to a second speed, which is faster than the first speed, until the mandrel 40 penetrates completely through the thickness of the upper and lower workpieces 112, 114. Once the mandrel 40 has penetrated both the upper and lower workpieces 112, 114 the speed at which the mandrel 40 is driven in the direction of penetration through the upper and lower workpieces 112, 114 is increased again to a third speed, which is faster than the second speed, until the head 60 of the mandrel 40 has completely penetrated through the lower surface 109 of the lower workpiece 114 and beyond and until the shank 25 of the rivet body 20 also moves through the apertures 111a, 111b formed through the overlapping workpieces 112, 114.

Accordingly, for a given speed of rotation of the mandrel 40 the speed at which the mandrel 40 is driven in the direction of penetration through the upper and lower workpieces 112, 114 can be increased one or more times throughout the course of penetrating through the overlapping upper and lower workpieces 112, 114 to reduce the overall amount of time taken to complete the method of joining the upper workpiece 112 to the lower workpiece 114 using the rivet 10.

Referring to FIG. 3C, after penetration of the head 60 of the mandrel 40 through the overlapping workpieces 112, 114, the head 60 continues further through the first and second apertures 111A, 111B formed through the overlapping workpieces 112, 114 and extends a distance beyond the lower surface 109 of the lower workpiece 114. The upper displaced portion 121 and the lower displaced portion 122 are received and captured within the opening 90 within the head 60 of the mandrel 40. The opening 90 is also configured to accommodate the upper displaced portion 121 and the lower displaced portion 122 upon the penetration of the mandrel 40 through the upper and lower workpieces 112, 114. The shank 25 of the rivet body 20 follows the head 60 of the mandrel 40 into the apertures 111A, 111B formed through the overlapping workpieces 112, 114.

FIG. 3D illustrates the mandrel 40 and the shank 25 of the rivet body 20 having moved through the apertures 111A, 111B formed through the overlapping workpieces 112, 114 until the cap 12, and in particular the workpiece engaging surface 16 of the cap 12, abuts with the upper surface 113 of the upper workpiece 112. The abutment of the cap 12 with the upper surface 113 of the upper workpiece 112 prevents the shank 25 of the rivet body 20 from passing entirely through the apertures 111A, 111B formed through the overlapping workpieces 112, 114.

Referring to FIG. 3E, after the rivet 10 has penetrated the overlapping workpieces 112, 114 to the point where the cap 12 comes into contact with the upper surface 113 of the upper workpiece 112, a force indicated in FIG. 3E by an arrow is applied to the mandrel 40 in a direction substantially along the longitudinal axis Y from the second end 24 towards the first end 22 of the rivet body 20. The application of a force to the mandrel 40 in a direction substantially along the longitudinal axis Y from the second end 24 towards the first end 22 of the rivet body 20 causes the mandrel 40 to be drawn or retracted into the axial passage 30 within the shank 25 of the rivet body 20. To apply the force to the mandrel 40 and thereby achieve the drawing or retracting of the mandrel 40, the stem 50 may be gripped by any suitable means, including by a gripping tool (not shown), and the force applied to the mandrel 40 via the gripping tool in the direction substantially along the direction of the longitudinal axis X of the mandrel 40 in a direction from the distal end 52 towards the proximal end 51 of the stem 50. An opposing force may be applied to the cap 12 in a direction substantially along the longitudinal axis Y of the rivet body 20 from the first end 22 towards the second end 24 of the rivet body 20 to help prevent the rivet body 20 from being withdrawn from the first and second apertures 111A, 111B within the upper and lower workpieces 112, 114.

The drawing or retraction of the mandrel 40 initially causes the radially narrower portion 72A of the rivet body engaging surface 72 to come into contact and engage with the mandrel engaging surface 26 of the rivet body 20. When a sufficient drawing or retraction force is applied to the rivet 40, the second end 24 of the shank 25 of the rivet body 20 deforms and expands radially outwardly from the longitudinal axis Y of the rivet body 20 to conform with the tapered profile of the rivet body engaging surface 72. As the shank 25 of the rivet body 20 deforms and expands radially outwardly the radially narrower portion 72A moves progressively further into the axial passage 30 within the rivet body 20. Also, the radial expansion of the second end 24 of the shank 25 of the rivet body 20 results in the external surface 28 of the side wall 27 of the shank 25 spreading out over a portion of, and abutting with, the lower surface 109 of the lower workpiece 114. The radial expansion of the second end 24 of the shank 25 of the rivet body 20 also results in the external surface 28 of the side wall 27 of the shank 25 coming into contact with and engaging the first and second lateral surfaces 115A, 115B defining the first and second apertures 111A, 111B created by the penetration of the mandrel 40 through the upper and lower workpieces 112, 114. The rivet body 20 is not retracted back through the first and second apertures 111A, 111B by the force applied to draw or retract the mandrel 40 because of the abutment of the external surface 28 of the shank 25 with the lower surface 109 of the lower workpiece 114 and/or by the engagement of the external surface 28 of the shank 25 with the first and second lateral surfaces 115A, 115B defining the first and second apertures 111A, 111B.

Referring to FIG. 3F, the mandrel 40 is shown as having been drawn further within the axial passage 30 in a direction from the second end 24 towards the first end 22 of the rivet body 20 such that the head 60 of the mandrel 40 is positioned substantially entirely within the axial passage 30 within the rivet body 20. In addition, the displaced portion 120 remains captured and accommodated within the opening 90 in the head 60 of the mandrel 40 such that it too is substantially positioned entirely within the axial passage 30 of the shank 25 of the rivet body 20.

A problem that been recognised with existing FSR methods that utilise blind rivets with a mandrel is that the displaced portion, or flash, tends to conform to the shape of the head of the mandrel as the head penetrates and forms a hole through the workpiece and exits therefrom. The displaced material, or flash, may be pushed aside to a position surrounding the hole and the mandrel or may become detached from the workpieces altogether. It has been discovered that the forms of the method and the rivet 10 disclosed herein are able to core, receive and capture the displaced portion 120 within the opening 90 within the head 60 of the mandrel 40 as it penetrates and forms the first and second apertures 111A, 111B through the upper and lower workpieces 112, 114 and exits therefrom.

Thus, the displaced portion 120 does not remain part of either of the upper and lower workpieces 112, 114 and is not pushed aside to a position surrounding the first and second apertures 111A, 111B. Accordingly, the amount of any flash or other displaced matter surrounding the first and second apertures 111A, 111B is minimised. When the force indicated by arrow B in FIGS. 3E and 3F is applied to the mandrel 40 to cause the mandrel 40 to be drawn or retracted into the axial passage 30 within the shank 25 of the rivet body 20, to the extent that there is any flash or other displaced matter surrounding the first and second apertures 111A, 111B, this does not adversely affect the ability of the second end 24 of the shank 25 of the rivet body 20 to deform and expand radially outwardly. Furthermore, to the extent that there is any flash or other displaced matter surrounding the first and second apertures 111A, 111B this does not adversely prevent the head 60 of the mandrel 40 from being positioned substantially entirely within the axial passage 30 within the rivet body 20 as illustrated in FIGS. 3F, 3G and 3H

Referring to FIG. 3G, the stem 50 is disconnected from the head 60 of the mandrel 40 by severing the stem 50 at the distal end 52 thereof. The stem 50 may be severed from the head 60 of the mandrel 40 by any suitable means. One way of severing the stem 50 is to manually apply a force to the proximal end 51 of the stem 50 in the same direction as the longitudinal axis X of the mandrel 40 so that a tensile force is applied to the stem 50 that is sufficient to break the stem at the distal end 52 thereof. Breaking of the stem 50 may be assisted by providing a weakened portion (not shown) of the stem 50 at the distal end 52. As a result of severing the stem 50 from the head 60, as illustrated in FIG. 3G, only the rivet body 20 and the head 60 of the mandrel 40 remain connected to the upper workpiece 112 and the lower workpiece 114.

FIG. 3H illustrates the overlapping portions of the upper workpiece 112 and the lower workpiece 114 joined together by the rivet 10. As can be seen in FIG. 3H, the external surface 28 of the shank 25 of the rivet body 20 is positioned within the first and second apertures 111A, 111B through the upper and lower workpieces 112, 114, created as a result of the penetration of the head 60 of the mandrel 40 therethrough. Furthermore, the workpiece engaging surface 16 of the cap 12 is shown in abutment with the upper surface 113 of the upper workpiece 112. Furthermore, the external surface 28 of the shank 25 of the rivet body 20 has been enlarged radially outwardly to engage the first and second lateral surfaces 115A, 115B of the first and second apertures 111A, 111B through the upper and lower workpieces 112, 114 and such that at least a portion of the external surface 64 at the second end 24 is in abutment with the lower surface 109 of the lower workpiece 114. Thus by engaging the first and second lateral surfaces 115A, 115B of the first and second apertures 111A, 111B the overlapping portions of the upper workpiece 112 and lower workpiece 114 are retained together, or joined, by the rivet body 20. To some extent, the overlapping portions of the upper workpiece 112 and lower workpiece 114 are clamped together between the workpiece engaging surface 16 of the cap 12 and the external surface 28 of the rivet body 20 in engagement with the first and second lateral surfaces 115A, 115B of the first and second apertures 111A, 111B and the lower surface 115 of the lower workpiece 114.

As will be appreciated, the displaced portion 120 remains captured and accommodated within the opening 90 of the head 60 after the process of joining the overlapping portions of the upper workpiece 112 and the lower workpiece 114 by the rivet 10 is completed. Thus, the rivet 10 and the joining method disclosed above are advantageous in that the displaced portion 120 does not come loose from the upper workpiece 112 or the lower workpiece 114 as a result of the operation of penetrating and the joining the upper and lower workpieces 112, 114 by the rivet 10. Furthermore, the displaced portion 120 is retained to the joined upper and lower workpieces 112, 114 by the rivet 10 in a manner that is substantially resistant to the displaced portion 120 becoming detached from the upper and lower workpieces 112, 114 with the passage of time and/or as a result of the movement or vibration of the upper and lower workpieces 112, 114.

Referring to FIGS. 3F, 3G and 3H, after the process of joining the overlapping portions of the upper workpiece 112 and lower workpiece 114 by the rivet 10 is completed the displaced portion 120 is retained within the opening 90 within the head 60 of the mandrel 40. By remaining within the opening 90 within the head 60 of the mandrel 40 the displaced portion 120 reinforces the side wall 62 of the head 60 of the mandrel 40 which in turn reinforces the side wall 27 of the rivet body 20 against forces applied to the external surface 28 of the side wall 27 in a radially inward direction towards the longitudinal axis Y of the rivet body. Accordingly, the displaced portion 120 substantially prevents radial contraction of the side wall 62 of the mandrel 40 and the side wall 27 of the rivet body 20 which might otherwise arise as a result of forces applied by the first and second surfaces 115A, 115B to the external surface 28 of the side wall 27 of the rivet body 20 in a radially inward direction towards the longitudinal axis Y of the rivet body 20. The displaced portion 120 thereby prevents buckling or radial contraction of the side wall 62 of the mandrel 40 and the side wall 27 of the rivet body 20 against lateral forces applied by the first and second surfaces 115A, 115B to the external surface 28 of the side wall 27 of the rivet body 20.

The structural integrity of the rivet body 20 when positioned as illustrated in FIGS. 3F, 3G and 3H to join the overlapping portions of the upper and lower workpieces 112, 114 is enhanced by the ability of the mandrel 40 to receive, capture and accommodate the displaced portion 120 within the opening 90 within the head 60. As can be appreciated, the strength and durability of the join provided by the rivet 10 between the overlapping portions of the upper and lower workpieces 112, 114 is enhanced by the ability of the head 60 of the mandrel 40 to receive, capture and accommodate the displaced portion 120 within the opening 90 within the head 60.

As illustrated in FIGS. 3B to 3E, the displaced portion 120 is received through the entrance 85 into the opening within the head 60 of the mandrel 40 and accommodated therewithin. The displaced portion 120 may fit within the opening 90 such that the lateral surface 124 of the displaced portion 120 engages with the internal surface 66 of the side wall 62 of the head 60. Friction between the lateral surface 124 of the displaced portion 120 and the internal surface 66 of the side wall 62 may be sufficient to retain the displaced portion 120 within the opening 90 and substantially prevent unwanted removal of the displaced portion 120 from the opening 90. Alternatively, the shape and configuration of the internal surface 66 of the side wall 62 may be such as to capture and retain the displaced portion 120 within the opening 90 in a loose fit. Thus, forms of the invention are advantageous in that by capturing and retaining the displaced portion 120 within the opening 90 within the head 60 of the mandrel 40 the displaced portion 120 is prevented from becoming detached from the upper and lower workpieces 112, 114. Furthermore, forms of the invention enable the position of the displaced portion 120 to be controlled after penetration of the mandrel 40 through the upper and lower workpieces 112, 114.

The method illustrated in FIGS. 3A to 3H may further include a dwell period wherein penetration of the head 60 of the mandrel 40 through the overlapping upper and lower workpieces 112, 114 is temporarily suspended when the head 60 has penetrated to a predetermined depth through the overlapping upper and lower workpieces 112, 114. During the dwell period, although the penetration of the head 60 through the overlapping workpieces 112, 114 is suspended the mandrel 40 continues to rotate. Thus, during the dwell period, frictional heat generated by contact between the overlapping workpieces 112, 114 and the rotating initial workpiece contacting surface 100 and the internal and external surfaces 66, 64 of the side wall 62, can build up. The build up of frictional heat during the dwell period increases the plasticisation and softening of the overlapping workpieces 112, 114 to enable the head 60 of the mandrel 40 to displace and receive the displaced portion 120 of the overlapping upper and lower workpieces 112, 114 to form the respective apertures 111A, 111B therethrough more easily once movement of the mandrel 40 in the direction of penetration of the overlapping upper and lower workpieces 112, 114 has resumed after the dwell period. Thus, the dwell period is advantageous in that it may reduce the force required to enable the head 60 of the mandrel 40 to penetrate through the overlapping upper and lower workpiece 112, 114.

To enhance the effectiveness of the opening 90 of the head 60 of the mandrel 40 to capture and accommodate the displaced portion 120 the internal volume of the opening 90 can be increased to ensure that there is sufficient internal space within the opening 90 to receive all or substantially all of the displaced portion therewithin. This can be achieved by lengthening the dimension of the opening 90 in the direction of the axis X such as by lengthening the dimension of the sidewall 62 of the head 60 of the mandrel 40 in the direction of the axis X. The length of the sidewall 62 is preferably sufficient to ensure that the volume within the opening 90 can receive and accommodate and thereby capture most, if not all, of the displaced portion 120 therewithin. In one form, the length of the side wall 62 in the direction of the axis X is at least as long as the combined thicknesses of the overlapping upper and lower workpieces 112, 114. In another form, the length of the side wall 62 is substantially longer than the combined thicknesses of the upper and lower workpieces 112, 114. By providing that the internal volume of the opening 90 within the head 60 of the mandrel 40 is sufficient to capture and retain most, if not all, of the displaced portion 120 the internal surface 66 of the head 60 of the mandrel 40 can be in contact with a sufficient amount of the lower displaced portion 122 to ameliorate the possibility of the lower displaced portion 122 being inadvertently dislodged from within the opening 90.

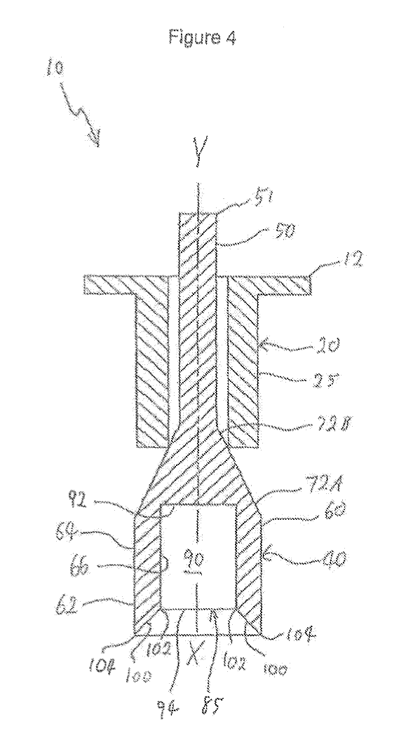

Referring to FIG. 4, an embodiment of the mandrel 40 is illustrated in which the initial workpiece contacting surface 100 has a frustoconical shape, faces towards and is oriented at an acute angle to the longitudinal axis X of the mandrel 40. The internal surface 66 of the side wall 62 and the initial workpiece contacting surface 100 meet at the inner edge 102 of the workpiece contacting surface at an obtuse angle. The initial workpiece contacting surface 100 extends from the inner edge 102 at an acute angle relative to the longitudinal axis X of the mandrel 40 to the outer edge 104 where the initial workpiece contacting surface 100 meets with the external surface 64 of the side wall 62 at an acute angle. Thus, the initial workpiece contacting surface 100 presents a relatively sharp outer edge 104 for contact with the upper surface 113 of the upper workpiece 112. This form of the invention is advantageous in that by presenting a relatively sharp outer edge 104 of the initial workpiece contacting surface 100 the amount of force required to cause the head 60 of the mandrel 40 to penetrate the plasticised and softened upper and lower workpieces 112, 114 is less than that which is required for arrangements of the mandrel 40 which have an initial workpiece contacting surface 100 that is substantially planar and oriented substantially transversely to the longitudinal axis X of the mandrel 40. This may be because the sharpened outer edge 104 of the initial workpiece contacting surface 100 imparts an enhanced cutting action to the upper and lower workpieces 112, 114 by concentrating the force applied to the mandrel 40 in the direction of penetration through the overlapping upper and lower workpieces 112, 114 to a smaller surface area of the upper surface 113 of the upper workpiece 112. The enhanced cutting action provided by the sharpened inner edge 104 of the initial workpiece contacting surface 100 in conjunction with the plasticisation effect provided by the frictional heat generated by the rotation of the initial workpiece contacting surface 100 enhances the ability of the mandrel 40 to penetrate the upper and lower workpieces 112, 114.

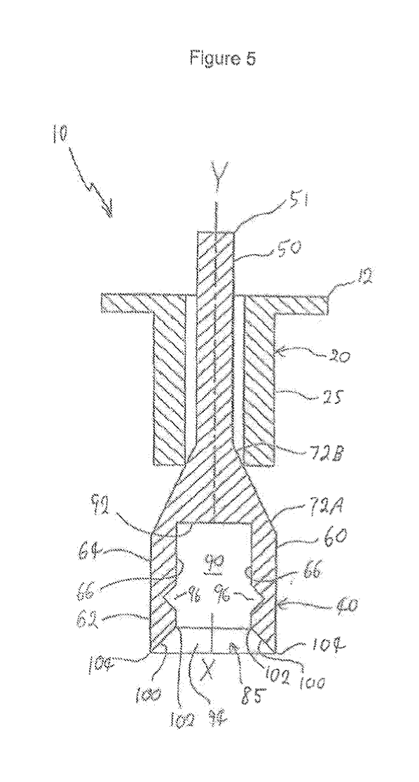

Referring to FIG. 5, another embodiment of the mandrel 40 is illustrated that includes an annular groove 96 in the internal surface 66 of the side wall 62 within the head 60 of the mandrel 40. When the head 60 of the mandrel 40 penetrates the upper and lower workpieces 112, 114, the displaced portion 120 which passes through the entrance 85 into the opening 90 abuts against the internal surface 66 and into positive engagement therewith. Furthermore, the displaced portion 120 at the lateral surface 124 is plasticised and softened and part of the displaced portion 120 at the lateral surface 124 may expand radially outwardly into the groove 96. As the displaced portion 120 cools and hardens the part of the displaced portion 120 at the lateral surface 124 that has expanded radially outwardly into the groove 96 positively engages the groove to enhance the ability of the mandrel 40 to prevent the displaced portion 120 from being dislodged from within the opening 90 within the head 60 of the mandrel 40. Accordingly, this form of the invention is advantageous in that it provides additional security against the displaced portion 120 being inadvertently removed from within the opening 90 in the head 60 of the mandrel 40.

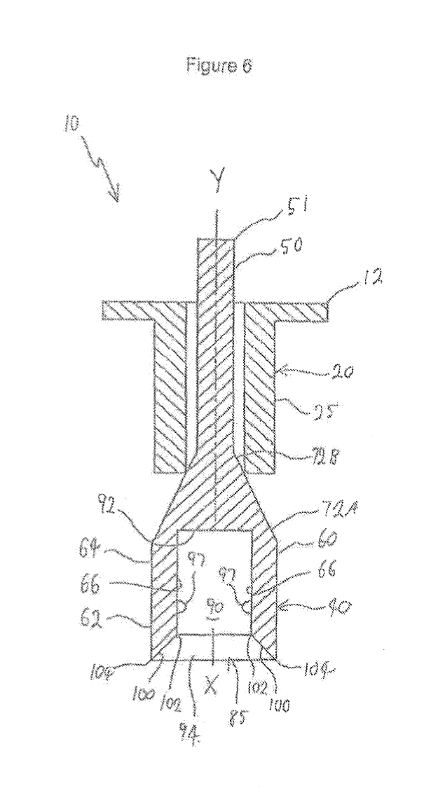

Referring to FIG. 6, another embodiment of the mandrel 40 is illustrated in which an annular projection 97 extends from the internal surface 66 and into the opening 90. As the head 60 penetrates the upper and lower workpieces 112, 114 and the displaced portion 120 passes through the entrance 85 and into the opening 90, the displaced portion 120 is plasticised and softened on the lateral surface 124 thereof such that the projection 97 deforms the lateral surface 124 of the displaced portion 120 to accommodate the projection. The lateral surface 124 of the displaced portion 120 is deformed by the projection 97 to provide a groove or the like in the lateral surface 124 into which the projection 97 is fitted. Once the displaced portion cools and hardens the projection 97 positively engages the groove formed in the lateral surface 124 of the displaced portion 120 to prevent the inadvertent removal of the displaced portion 120 from within the opening 90 in the head 60 of the mandrel 40.

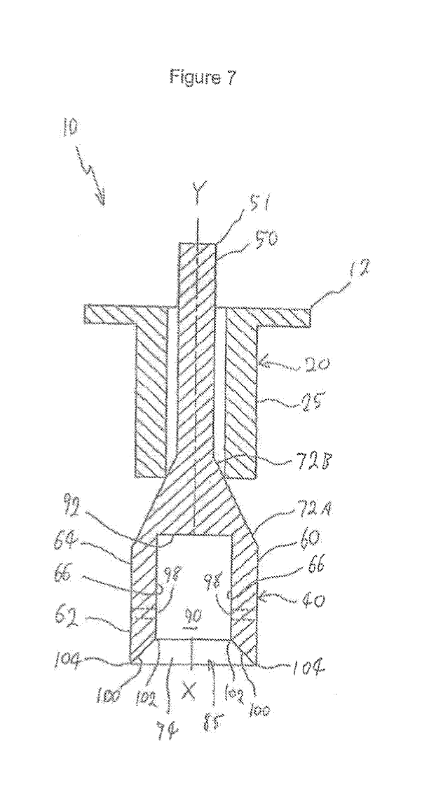

Referring to FIG. 7, another embodiment of the mandrel 40 is illustrated in which a transverse hole 98 extends from the opening 90 through the side wall 62 substantially perpendicularly relative to the longitudinal axis X of the mandrel 40. The transverse hole 98 has an entrance on the internal surface 66 of the side wall 62. When the head 60 penetrates the upper and lower workpieces 112, 114 the displaced portion 120 passes through the entrance 85 into the opening 90 and a portion of the plasticised and softened lateral surface 124 of the displaced portion 120 may expand radially outwardly through the entrance 99 and into the transverse hole 98. The portion of the lateral surface 124 of the displaced portion 120 that expands radially outwardly through the entrance 99 and into the transverse hole 98 subsequently cools and hardens to positively engage the transverse hole 98 and prevent the inadvertent removal of the displaced portion 120 from within the opening 90 in the head 60 of the mandrel 40.

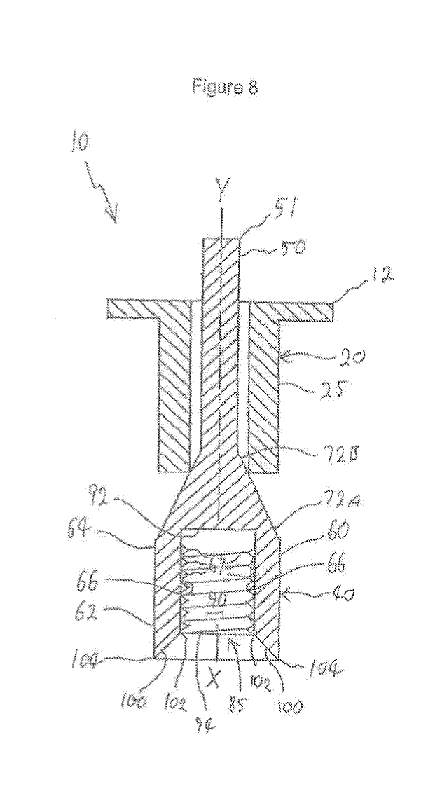

Referring to FIG. 8 there is shown another form of the rivet 10 in which the internal surface 66 of the side wall 62 of the head 60 includes a plurality of inwardly projecting ridges 67. The ridges 67 may be in the form of an internal thread on the internal surface 66 of the side wall 62. The ridges 67 are advantageous in that they positively engage the lateral surface 124 of the displaced portion 120 to prevent the inadvertent removal of the displaced portion 120 from within the opening 90 in the head 60 of the mandrel 40.

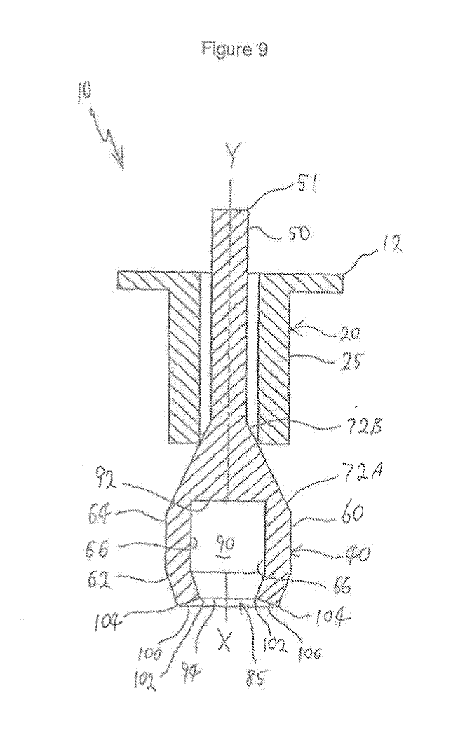

Referring to FIG. 9, there is illustrated another embodiment of the mandrel 40 in which the side wall 62 of the head 60 of the mandrel tapers radially inwardly at the distal end 80 of the head 60. Thus, the radial diameter of the opening 90 progressively decreases towards the distal end 94 of the opening 90. Thus, the radial diameter of the opening 90 is less at the distal end 94 than at the proximal end 92 and the internal surface 66 of the side wall 62 tapers radially inwardly towards the longitudinal axis X of the mandrel 40. After the head 60 has penetrated the upper and lower workpieces 112, 114 and the displaced portion 120 has passed through the smaller diameter portion at the distal end 94 of the opening 90 and into the larger diameter portion at the proximal end 92 of the opening 90, the plasticised lateral surface 124 of the displaced portion 120 expands radially outwardly. The expanded lateral surface 124 of the displaced portion 120 conforms to the shape of the tapering internal surface 66 of the side wall 62. By conforming to the shape of the internal surface 66 of the side wall 62 the displaced portion 120 dovetails within the opening 90 to increase the retention and resistance to inadvertent removal of the displaced portion 120 from within the opening 90 in the mandrel 40.

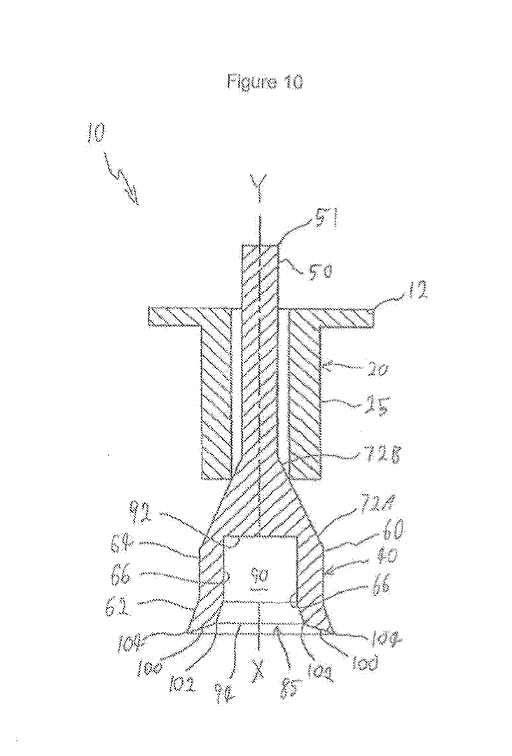

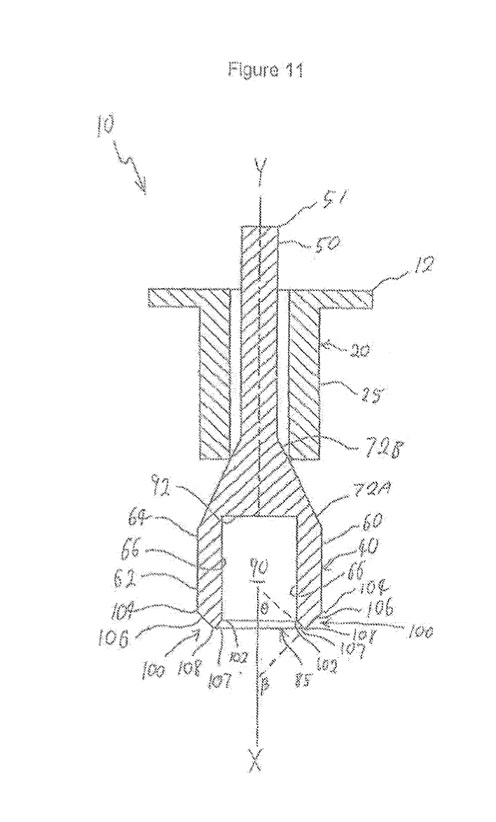

Because the side wall 62 of the head 60 in the embodiment of FIG. 9 tapers such the radial diameter of the opening 90 progressively decreases towards the distal end 94 thereof the internal volume defined within the opening 90 is less than if the side wall 62 of the head 60 did not taper and was substantially straight in the direction of the axis X. To improve the effectiveness of the opening 90 to receive and capture the displaced portion 120 therewithin in embodiments of the mandrel 40 where the side wall 62 tapers the overall length of the side wall 62 in the direction of the axis X is increased as compared with embodiments of the mandrel 40 in which the side wall 62 of the head 60 extends in a substantially straight direction in the direction of the axis X or flares outwardly such as in the embodiment illustrated in FIG. 10 described below.

Referring to FIG. 10 an embodiment of the mandrel 40 is illustrated in which the side wall 62 of the head 60 of the mandrel flares radially outwardly at the distal end 80 of the head 60. Thus, the radial diameter of the opening 90 progressively increases towards the distal end 94 of the opening 90. Thus, the radial diameter of the opening 90 is greater at the distal end 94 than at the proximal end 92 and the internal surface 66 of the side wall 62 flares radially outwardly from the longitudinal axis X of the mandrel 40. Thus, the external surface 64 has a diameter that at the distal end 80 of the head 60 that is greater than a diameter of the external surface 64 at the proximal end 70. Also, from the distal end 94 to the proximal end 92 of the opening 90, the internal surface 66 of the side wall 62 tapers radially inwardly towards the longitudinal axis X of the mandrel 40. This form of the mandrel 40 is advantageous in that the diameter of the external surface 64 is greatest where it meets the outer edge 104 of the initial workpiece contacting surface 100. As such, the diameter of the first and second apertures 111A, 111B formed in the workpieces as a result of the penetration of the head 60 of the mandrel 40 therethrough is larger than the diameter of the side wall 62 towards the proximal end 70. Thus, a relatively lower force is required to enable the head 60 to penetrate the plasticised and softened upper and lower workpieces 112, 114 and may result in significantly reducing flash formation, if any, at the second aperture 111 B as a result of the penetration of the head 60 of the mandrel 40 through the upper workpiece 112 and/or the lower workpiece 114.

Referring to FIG. 11, another form of the mandrel 40 is illustrated wherein the initial workpiece contacting surface 100 includes a first sub-surface 107 and a second sub-surface 106. The first sub-surface 107 is a frustoconical surface that faces towards the longitudinal axis X of the mandrel 40. Furthermore, the first sub-surface 107 is oriented at an acute angle θ to the longitudinal axis X of the mandrel 40. The second sub-surface 106 is also a frustoconical surface that faces from the longitudinal axis X of the mandrel 40. The second sub-surface 106 is oriented at an obtuse angle β to the longitudinal axis X of the mandrel 40. As can be seen in FIG. 11, the first sub-surface 107 and the second sub-surface 106 extend respectively from the internal surface 66 and the external surface 64 of the side wall 62 and meet at an apex 108. By providing the first sub-surface 107 and the second sub-surface 106 at respective acute and obtuse angles to the longitudinal axis X of the mandrel 40, the amount of force applied to the mandrel 40 to cause it to penetrate the plasticised and softened upper and lower workpieces 112, 114 can be reduced. By reducing the acute angle at which the first sub-surface 107 is oriented to the longitudinal axis X and/or by increasing the obtuse angle at which the second sub-surface 106 is oriented to the longitudinal axis X of the mandrel 40 the force applied to the mandrel 40 to cause the head 60 to penetrate the plasticised and softened upper and lower workpieces 112, 114 can be progressively reduced even further. By reducing the acute angle at which the first sub-surface 107 is oriented to the longitudinal axis X and/or by increasing the obtuse angle at which the second sub-surface 106 is oriented to the longitudinal axis X of the mandrel 40 the apex 108 at which the first sub-surface 107 and second sub-surface 106 meet becomes increasingly sharper.

As mentioned above, greater sharpening of the apex 108 imparts an enhanced cutting action to the upper and lower workpieces 112, 114. Thus, greater sharpening, in conjunction with the plasticisation effect provided by the rotation of the mandrel 40 enables the mandrel to core the displaced portion 120 from the upper and lower workpieces 112, 114 upon penetration therethrough with less force applied to the mandrel 40 in the direction of penetration compared with other embodiments with less sharpening of the apex 108.

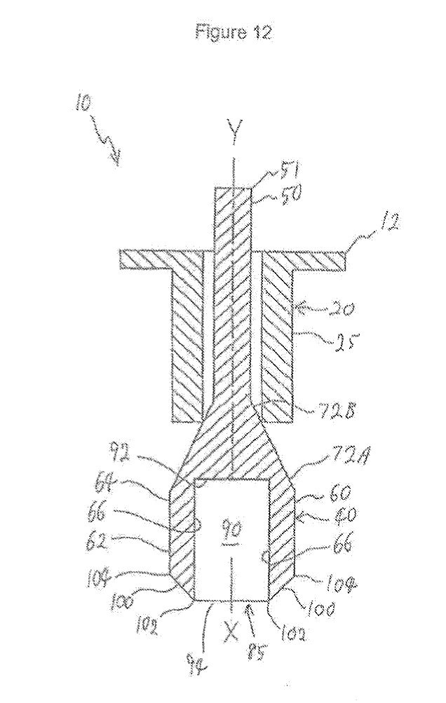

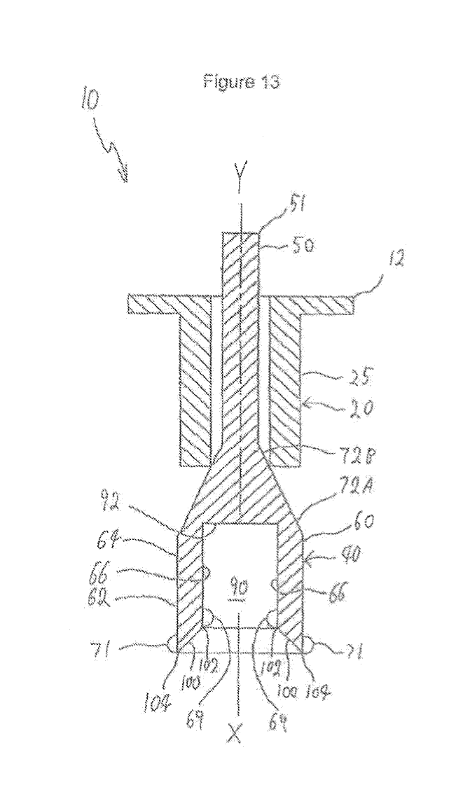

FIG. 12 illustrates another form of the mandrel 40 in which the initial workpiece contacting surface 100 is oriented at an obtuse angle relative to the longitudinal axis X of the mandrel 40. By orienting the initial workpiece contacting surface 100 at an obtuse angle relative to the longitudinal axis X of the mandrel 40 the inner edge 102 is sharpened. Similar to the embodiment illustrated in FIG. 11, the embodiment illustrated in FIG. 12 requires a lower force to be applied to the mandrel 40 in the direction indicated by the arrow A in FIGS. 3B and 3C to enable the head 60 to penetrate through the plasticised and softened upper and lower workpieces 112, 114. This is because the sharpened inner edge 102 of the initial workpiece contacting surface 100 imparts an enhanced cutting action to the upper and lower workpieces 112, 114. The enhanced cutting action provided by the sharpened inner edge 102 of the initial workpiece contacting surface 100 in conjunction with the plasticisation effect provided by the frictional heat generated by the rotation of the mandrel 40 may enable the mandrel 40 to penetrate the upper and lower workpieces 112, 114 and to core the displaced portion 120 therefrom with a lower force applied to the mandrel 40 in the direction indicated by the arrow A in FIGS. 3B and 3C when compared with some other embodiments described above which do not incorporate the sharpened inner edge 102.

FIG. 13 illustrates another form of the rivet 10 in which an internal annular projection 69 extends from the internal surface 66 and into the opening 90 and an external annular projection 71 extends from the external surface 64 of the side wall 62. As the head 60 penetrates the upper and lower workpieces 112, 114 and the displaced portion 120 passes through the entrance 85 and into the opening 90 the displaced portion 120 is plasticised and softened on the lateral surface 124 thereof such that the projection 69 deforms the lateral surface 124 of the displaced portion 120 to accommodate the projection 69. The lateral surface 124 of the displaced portion 120 is deformed by the projection 69 to provide a groove or the like in the lateral surface 124 into which the projection 69 is fitted. Once the displaced portion 120 cools and hardens the projection 69 positively engages the groove formed in the lateral surface 124 of the displaced portion 120 to prevent the inadvertent removal of the displaced portion 120 from within the opening 90 in the head 60 of the mandrel 40. As the head 60 penetrates the upper and lower workpieces 112, 114 the external projection 71 forms the apertures 111A and 111B with diameters that are larger than the diameter of the external surface 64 of the side wall 62 to provide a clearance therebetween. Thus, a relatively lower force is required to enable the head 60 to penetrate the plasticised and softened upper and lower workpieces 112, 114 and may result in significantly reducing flash formation, if any, at the second aperture 111B as a result of the penetration of the head 60 of the mandrel 40 through the upper workpiece 112 and/or the lower workpiece 114.

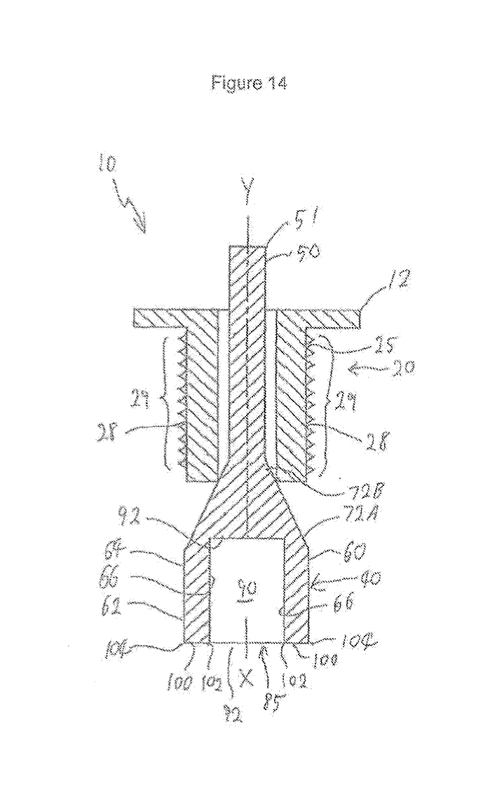

Referring to FIG. 14 there is shown another form of the rivet 10 in which the external surface 28 of the rivet body 20 includes a plurality of projections or ridges 29 projecting radially outwardly from the external surface 28. The ridges 29 may be in the form of an external thread on the external surface 28 of the rivet body 20. The ridges 29 on the external surface 28 of the rivet body 20 engage the lateral surfaces 115A, 115B of the respective first and second apertures 111A, 111B through the upper and lower workpieces 112, 114 to further ensure against the inadvertent withdrawal of the rivet body 20 from within the apertures 111A, 111B. By engaging the lateral surfaces 115A, 115B of the apertures 111A, 111B the ridges 29 enhance the ability of the rivet body 20 to maintain the upper and lower workpieces 112, 114 joined together. The ridges 29 are advantageous in that they enhance the ability of the rivet body 20 to resist tensile shear loading and any resultant relative movement of the upper and lower workpieces 112, 114.

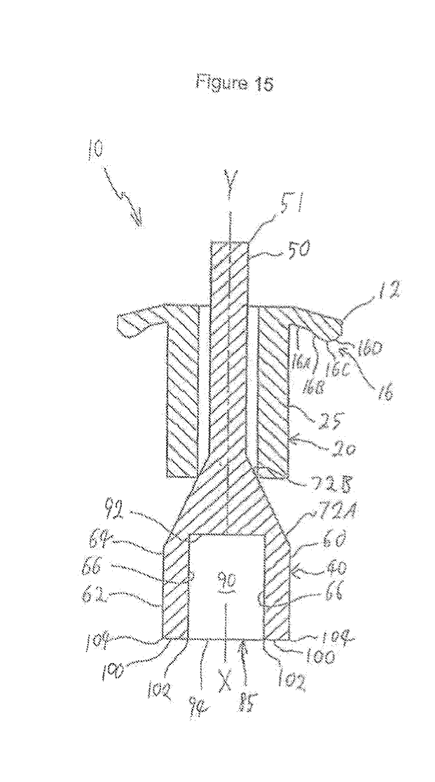

Referring to FIG. 15 there is shown another form of the rivet 10 in which the workpiece engaging surface 16 of the cap 12 includes portions that are oriented at a variety of angles to the longitudinal axis Y of the rivet body 20. A first portion 16A of the workpiece engaging surface 16 located radially inwardly faces towards and is oriented to the longitudinal axis Y of the rivet body 20 at an acute angle. A second portion 16B of the workpiece engaging surface 16 located radially outwardly from the first portion 16A faces towards and is oriented to the longitudinal axis Y of the rivet body 20 at a more acute angle than the first portion 16A. A third portion 16C of the workpiece engaging surface 16 located radially outwardly from the first and second portions 16A, 16B, does not face towards or away from the longitudinal axis Y and is oriented substantially perpendicularly to the longitudinal axis Y. A fourth portion 16D of the workpiece engaging surface 16 located radially outwardly from the first, second and third portions 16A, 16B, 16C faces away from and is oriented to the longitudinal axis Y of the rivet body 20 at an obtuse angle. Thus, the first, second, third and fourth portions 16A, 16B, 16C, 16D of the workpiece engaging surface 16 are oriented at differing angles relative to the shank 25 of the rivet body 20. This form of the rivet 10 facilitates influencing the amount of force applied by the workpiece engaging surface 16 to the upper surface 113 of the upper workpiece 112 and may result in forging the softened and plasticised upper and lower workpieces 112, 114 in the vicinity immediately surrounding the apertures 111A and 111B and an additional bond between the overlapping upper and lower workpieces 112, 114. This form of the cap 12 may also provide a means to accommodate and compress any flash formation on the upper surface 113 of the upper workpiece 112 surrounding the aperture 111A.

Referring to FIGS. 1 to 15, the various shapes and configurations of the head 60 of the mandrel 40 set out above may result in the formation of respectively different shapes and configurations of the displaced portion 120. Thus, the shape and configuration of the displaced portion 120 formed by the head 60 of the embodiment of FIG. 4 with its initial workpiece contacting surface 100 having a sharper outer edge 104 may be significantly different to the shape and configuration of the displaced portion 120 formed by the head 60 of the embodiment of FIG. 12 with its sharper inner edge 102. Similarly, the head 60 of the embodiment of FIG. 11 with its blunter outer edge 104 and blunter inner edge 102 and its sharper apex 108 may result in the formation of yet another substantially different shaped and configured displaced portion 120.

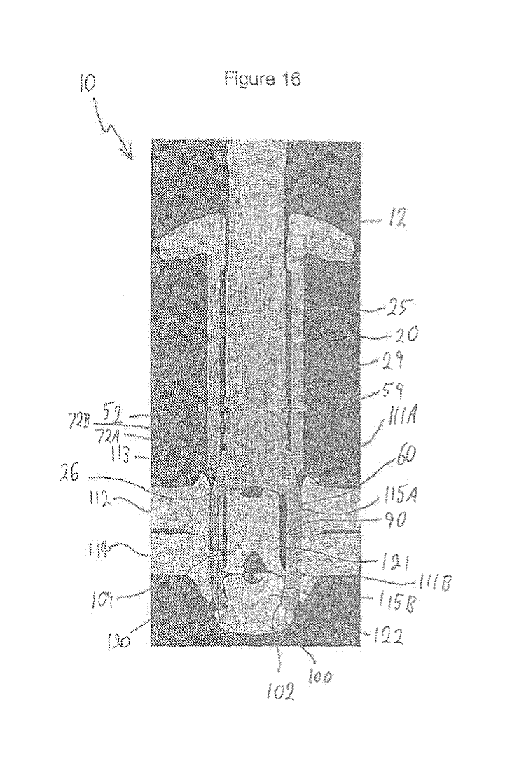

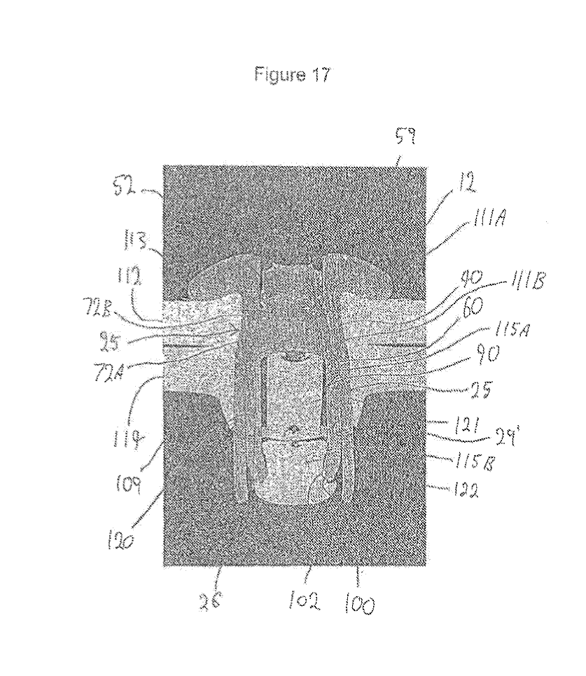

FIGS. 16 and 17 are photographs illustrating in more detail the steps of the joining method illustrated in FIGS. 3B and 3H. In FIG. 16, the initial workpiece contacting surface 100 has penetrated through the upper workpiece 112 and lower workpiece 114 and has received the displaced portion 120, including the upper displaced portion 121 and the lower displaced portion 122, from the upper workpiece 112 and the lower workpiece 114. The upper and lower displaced portions 121, 122 are positioned within the opening 90 within the head 60 of the mandrel 40 and the first and second apertures 111A, 111B are respectively formed within the upper and lower workpieces 112, 114 as a result of the penetration of the head 60 therethrough. The first and second lateral surfaces 115A, 115B of the respective upper and lower displaced portions 121, 122 face towards and contact the internal surface 66 defining the opening 90 within the head 60 of the mandrel 40.

In FIG. 17 the external surface 28 of the shank 25 of the rivet body 20 has been enlarged radially outwardly to engage the first and second lateral surfaces 115A, 115B of the first and second apertures 111A, 111B through the upper and lower workpieces 112, 114. By engaging the first and second lateral surfaces 115A, 115B of the first and second apertures 111A, 111B the overlapping portions of the upper workpiece 112 and lower workpiece 114 are retained together, or joined, by the rivet body 20. Furthermore, the upper and lower displaced portions 121, 122 remain positioned within the opening 90 within the head 60 of the mandrel 40.

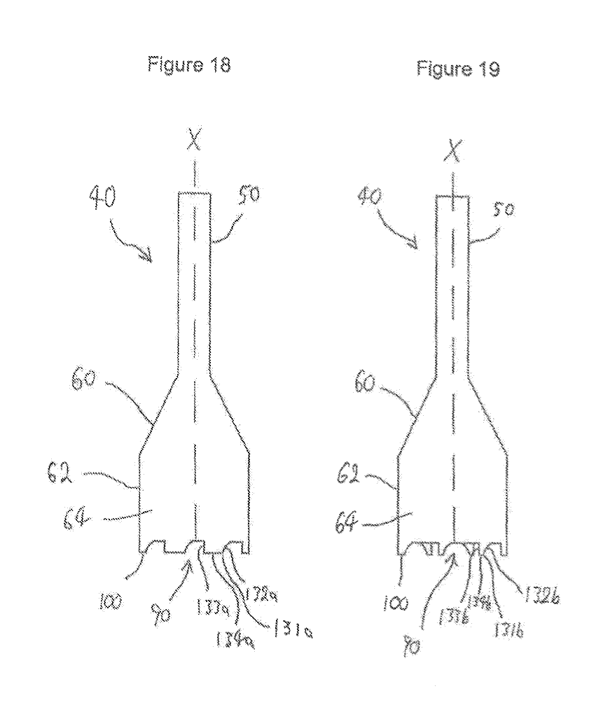

In FIGS. 18 and 19 further embodiments of the mandrel 40 are illustrated in which the initial workpiece contacting surface 100 is serrated. Accordingly, the initial workpiece contacting surface 100 of the embodiments of FIGS. 18 and 19 include sets of teeth 131a, 131b, respectively. In the embodiment illustrated in FIG. 18, each one of the teeth 131a includes a sloping surface 132a and a straight surface 133a extending in the direction of the longitudinal axis X of the mandrel 40. The sloping surface 132a and the straight surface 133a are connected by a flat surface 134a which is oriented substantially perpendicularly to the axis X. The mandrel 40 illustrated in FIG. 19 also includes a set of teeth 131b including a sloping surface 132b and a straight surface 133b extending in the direction of the longitudinal axis X of the mandrel 40. The sloping surface 132b and the straight surface 133b are connected by a flat surface 134b which is oriented in a direction substantially perpendicularly to the axis X. However, in contrast to the flat surface 134a of the mandrel 40 of FIG. 18, the flat surface 134b of the mandrel 40 of FIG. 19 has a significantly shorter width in the direction perpendicular to the axis X. As such, the teeth 131b of the mandrel 40 of FIG. 19 are substantially sharper than the relatively blunt teeth 131a of the mandrel 40 of FIG. 18. In another form, the flat surface 134b of the mandrel 40 of FIG. 19 can be done away with altogether such that the sloping surface 132b and the straight surface 133b meet directly at a point so as to provide teeth that are even sharper than the teeth 131a, 131b of the embodiments of FIGS. 18 and 19.

An advantage of the embodiments of the mandrel 40 illustrated in FIGS. 18 and 19 is that, with the provision of teeth 131a, 131b, for a given speed of rotation of the mandrel 40 the magnitude of the force required to be applied to the mandrel 40 in the direction of penetration of the upper and lower workpieces 112, 114 to cause penetration therethrough is substantially less than if the workpiece contacting surface 100 of the mandrel 40 is substantially continuous or flat such as in the embodiments of the mandrel 40 illustrated in FIGS. 1 to 15. Furthermore, variations in the depth of each of the teeth 131a, 131b alters the amount of force required to be applied to the mandrel 40 in the direction of penetration of the upper and lower workpieces 112, 114. In particular, embodiments of the teeth 131a, 131b which have a greater depth require a lesser force to be applied to the mandrel 40 in the direction of penetration of the upper and lower workpieces 112, 114 to achieve penetration than for teeth 131a, 131b having a relatively shallower depth. Furthermore, the sharper teeth 131b of the embodiment illustrated in FIG. 19 requires a significantly lower force to be applied to the mandrel 40 in the direction of penetration of the upper and lower workpieces 112, 114 than the relatively blunt teeth 131a of the embodiment of the mandrel 40 illustrated in FIG. 18.

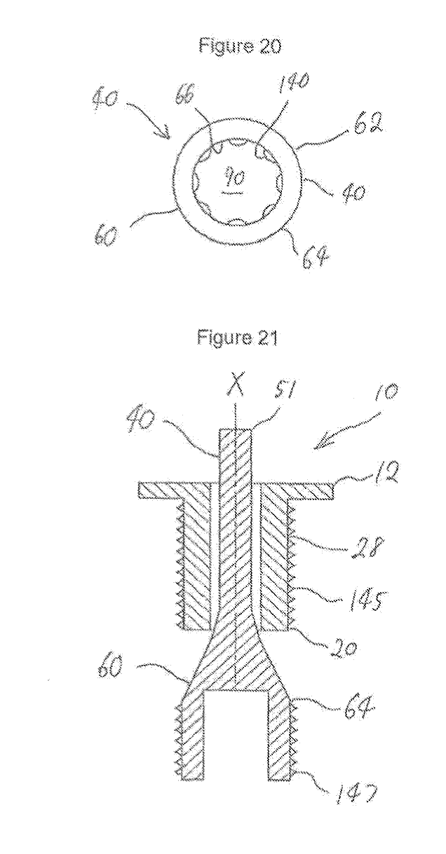

FIG. 20 illustrates another embodiment of the mandrel 40 including a plurality of internal projections 140 extending radially inwardly from the internal surface 66 and into the opening 90 within the head 60 of the mandrel 40. Each one of the internal projections 140 is spaced apart from each other about the circumferential direction of the internal surface 66. Unlike the embodiment illustrated in FIG. 13, the arrangement illustrated in FIG. 20 does not include external projections on the external surface 64 of the side wall 62 of the head 60 of the mandrel 40. The purpose of the plurality of internal projections 140 is to grip the displaced portion 120 which is displaced from the upper and lower workpieces 112, 114 as the head 60 of the mandrel 40 penetrates therethrough. Similar to the embodiment illustrated in FIG. 13, as the head 60 of the mandrel 40 of FIG. 20 penetrates through the upper and lower workpieces 112, 114 the lateral surface 124 of the displaced portion 120, which is in a plasticised state, is deformed by the internal projections 140 to provide a groove or the like in the lateral surface 124 into which the internal projections 140 are received. Once the displaced portion 120 cools and hardens the internal projections 140 positively engage the groove or grooves formed in the lateral surface 124 of the displaced portion 120 to prevent the inadvertent removal of the displaced portion 120 from within the opening 90 in the head 60 of the mandrel 40.

FIG. 21 illustrates another embodiment of the rivet 10 in which the external surface 28 of the rivet body 20 includes a plurality of projections or ridges or more particularly a helical thread 145 projecting radially outwardly from the external surface 28. The external surface 64 of the head 60 of the mandrel 40 also includes a plurality of projections or ridges or more particularly a helical thread 147 projecting radially outwardly from the external surface 64. As the mandrel 40 is rotated and a force is applied to the mandrel 40 in the direction of penetration through the upper and lower workpieces 112, 114 to thereby cause plasticisation of the upper and lower workpieces 112, 114 and penetration therethrough initially the thread 147 of the mandrel 40 engages the lateral surfaces 115a, 115b of the first and second apertures 111a, 111b formed through the upper and lower workpieces 112, 114. The engagement of the thread 147 of the mandrel 40 with the lateral surfaces 115a, 115b tends to direct swarf material of the upper and lower workpieces 112, 114 out of the apertures 111a, 111b in the direction opposite to the direction of penetration of the mandrel 40 through the upper and lower workpieces 112, 114. Similarly, as the head 60 of the mandrel 40 penetrates through the upper and lower workpieces 112, 114 and the rivet body 20 begins to penetrate the upper and lower workpieces 112, 114 the thread 145 on the external surface 28 of the rivet body 20 similarly directs swarf material from the upper and lower workpieces 112, 114 out of the first and second apertures 112a, 112b in a direction opposite to the direction of penetration of the mandrel 40 and the rivet body 20 therethrough.

An advantage of the embodiment of FIG. 21 is the minimisation of flash formation at the interface between the upper and lower workpieces 112, 114 and resulting minimisation of any gap formed between the upper and lower workpieces 112, 114 after the completion of the joining method. Furthermore, this embodiment tends to minimise the formation of flash protruding from the lower surface 109 of the lower workpiece 114 adjacent to the second aperture 111b. Furthermore, the provision of the threads 145, 147 on the external surfaces 28, 64 of the rivet body 20 and the head 60 of the mandrel 40 respectively requires a lower magnitude of force to be applied to the mandrel 40 in the direction of penetration of the upper and lower workpieces 112, 114 to cause penetration of the head 60 of the mandrel 40 and the rivet body 20 therethrough. However, to minimise the possibility that the provision of the thread 145, 147 on the external surface 28, 64 on the rivet body 20 and the head 60 of the mandrel 40 respectively will result in weakening the side wall 62 of the head 60 of the mandrel 40 and the rivet body 20 it is preferable to ensure that the thickness of the side wall 62 of the head 60 of the mandrel 40 and the rivet body 20 is not substantially reduced as a result of the provision of the threads 145, 147 on the external surfaces 64, 28 thereof.

In other forms, either the external surface 28 of the rivet body 20 includes a plurality of projections or ridges or more particularly a helical thread 145 projecting radially outwardly from the external surface 28 or the external surface 64 of the head 60 of the mandrel 40 includes a plurality of projections or ridges or more particularly a helical thread 147 projecting radially outwardly from the external surface 64.

In the rivets 10 illustrated in FIGS. 16 and 17, the stem 50 includes a groove 59 which acts to provide a weakened portion of the stem 50 at the distal end 52. Thus, the groove 59 assists in severing the stem 50 from the head 60 so that, as illustrated in FIG. 16, only the rivet body 20 and the head 60 of the mandrel 40 remain connected to the upper workpiece 112 and the lower workpiece 114.

The process and the rivet 10 set out above are applicable for joining upper and lower workpieces 112, 114 made of various materials including aluminium, magnesium and other metals and metal alloys and metal-based composites and non-metallic materials including polymers and their composites, whether they be in sheet form or any other form capable of being penetrated by the rivet 10. Typically, the material used to form the rivet 10, and in particular the mandrel 40, will have a higher melting point than the material forming the upper and lower workpieces 112, 114, however, it may be possible to form the mandrel 40, or part of the mandrel 40, out of material that has a lower melting point than the material forming the upper and lower workpieces 112, 114.

It will be apparent that variations, modifications, alterations and additions to the forms of the rivet 10 and the joining method incorporating the advantages of receiving and capturing the displaced portion 120 of the upper workpiece 112 and lower workpiece 114 that is displaced as a result of the penetration of the head 60 of the mandrel 40 therethrough are possible. All such arrangements falling within the scope of the technical advancement disclosed herein are within the scope of the invention. Accordingly, various alterations, modifications and/or additions may be introduced into the constructions and arrangements of parts previously described without departing from the spirit and/or ambit of the invention.

1-36. (canceled)

37. A method of joining two or more metallic workpieces with a blind rivet, the method including:
positioning a blind rivet at a point of overlap of two or more metallic workpieces, the blind rivet including a rivet body and a mandrel;
rotating the mandrel about a longitudinal axis thereof and contacting the mandrel with the overlapping workpieces, wherein the mandrel is rotated at a speed to cause plasticization of the overlapping workpieces;
causing the mandrel to penetrate through the plasticized overlapping workpieces and form an aperture therethrough,
capturing a portion of the overlapping workpieces that is displaced upon the penetration of the mandrel; and
securing the rivet body within the aperture to join the overlapping workpieces.

38. The method of claim 37, wherein capturing the portion of the overlapping workpieces that is displaced upon the penetration of the mandrel includes the mandrel capturing the portion of the overlapping workpieces.

39. The method of claim 37, wherein capturing the portion of the overlapping workpieces that is displaced upon the penetration of the mandrel includes capturing the portion of the overlapping workpieces in an opening within the mandrel.

40. The method of claim 37, further including accommodating the portion of the workpiece that is displaced upon penetration of the mandrel through the workpiece within the opening in the mandrel which is open in the direction of penetration of the mandrel through the overlapping workpieces.

41. The method of claim 37, wherein the rivet body includes a shank having a first end, a second end and an axial passage extending through the shank between the first and second ends and an external surface facing radially outwardly from the axial passage with projections extending outwardly from the external surface for engaging the overlapping workpieces within the aperture thereof.

42. The method of claim 41, wherein the mandrel includes a shaft with a head at one end, the shaft being positioned within the axial passage with the head at the second end of the shank, whereby securing the rivet body within the aperture to join the overlapping workpieces includes drawing the head into the axial passage whereby the shank expands radially outwardly within the aperture which causes the external projections to further engage the overlapping workpieces.

43. The method of claim 37, wherein rotating the mandrel includes rotating the mandrel at from about 1000 to about 20000 revolutions per minute.

44. The method of claim 37, wherein causing the mandrel to penetrate through the plasticized overlapping workpieces includes driving the mandrel at a rate of from about 10 to about 1000 mm per minute.

45. The method of claim 37, further including a dwell period wherein penetration of the mandrel through the overlapping workpieces is temporarily suspended when the mandrel has penetrated to a predetermined depth through the overlapping workpieces while the mandrel continues to rotate.

46. The method of claim 37, wherein the speed of penetration of the mandrel through the overlapping workpieces changes one or more times.

47. A method of joining two or more metallic workpieces with a blind rivet, the method including:
positioning a blind rivet at a point of overlap of two or more metallic workpieces, the blind rivet including a rivet body and a mandrel;
rotating the mandrel about a longitudinal axis thereof and contacting the mandrel with the overlapping workpieces, wherein the mandrel is rotated at a speed to cause plasticization of the overlapping workpieces;
causing the mandrel to penetrate through the plasticized overlapping workpieces and form an aperture therethrough, wherein the mandrel cores a portion of the overlapping workpieces that is displaced upon the penetration of the mandrel therethrough;
securing the rivet body within the aperture to join the overlapping workpieces.

48. The method of claim 47, wherein causing the mandrel to penetrate through the plasticized overlapping workpieces whereby the mandrel cores a portion of the overlapping workpieces that is displaced upon the penetration of the mandrel therethrough includes removing a substantially cylindrical portion of the overlapping workpieces.

49. The method of claim 47, further including receiving the displaced portion of the overlapping workpieces within an opening in the mandrel which is open in the direction of penetration of the mandrel through the overlapping workpieces.

50. The method of claim 49, wherein rotating the mandrel about a longitudinal axis thereof and contacting the mandrel with the overlapping workpieces includes rotating and contacting a surface positioned radially outwardly from the opening in the mandrel with the overlapping workpieces.

51. The method of claim 47, further including capturing the displaced portion of the overlapping workpieces.

52. The method of claim 47, wherein causing the mandrel to penetrate through the plasticized overlapping workpieces includes driving the mandrel through the plasticized overlapping workpieces.

53. The method of claim 47, wherein the rivet body includes a shank having a first end, a second end and an axial passage extending through the shank between the first and second ends and an external surface facing radially outwardly from the axial passage with projections extending outwardly from the external surface for engaging the overlapping workpieces within the aperture thereof.

54. The method of claim 53, wherein the mandrel includes a shaft with a head at one end, the shaft being positioned within the axial passage with the head at the second end of the shank, whereby securing the rivet body within the aperture to join the overlapping workpieces includes drawing the head into the axial passage whereby the shank expands radially outwardly within the aperture which causes the external projections to further engage the overlapping workpieces.

55. The method of claim 47, wherein rotating the mandrel includes rotating the mandrel at from about 1000 to about 20000 revolutions per minute.

56. The method of claim 47, wherein causing the mandrel to penetrate through the plasticized overlapping workpieces includes driving the mandrel at a rate of from about 10 to about 1000 mm per minute.

57. The method of claim 47, further including a dwell period wherein penetration of the mandrel through the overlapping workpieces is temporarily suspended when the mandrel has penetrated to a predetermined depth through the overlapping workpieces while the mandrel continues to rotate.

58. The method of claim 47, wherein the speed of penetration of the mandrel through the overlapping workpieces changes one or more times.

59. A metallic workpiece penetrating and joining blind rivet, the blind rivet including:
a rivet body including a shank having a first end, a second end and an axial passage extending through the shank between the first and second ends;
a mandrel including a shaft positioned within the axial passage and a head at one end of the shaft for contacting a metallic workpiece,
wherein the mandrel is configured so that when contacting the workpiece, being rotated about a longitudinal axis thereof at a speed to cause plasticization of the workpiece and being caused to penetrate through the plasticized workpiece the mandrel cores a portion of the plasticised workpiece, displaces the portion from the workpiece and forms an aperture in the workpiece.

60. The rivet of claim 59, wherein the head of the mandrel includes a workpiece contacting surface positioned radially outwardly from the longitudinal axis of the mandrel and an opening positioned radially inwardly from the workpiece contacting surface wherein the workpiece contacting surface cores the portion of the workpiece and the opening is open in the direction of penetration of the mandrel through the workpiece for receiving the portion of the workpiece.

61. The rivet of claim 60, wherein the opening is configured to capture the portion of the workpiece that is displaced upon penetration of the mandrel therethrough.

62. The rivet of claim 60, wherein the opening is substantially cylindrical.

63. The rivet of claims 60, wherein the opening has a proximal end and a distal end and a diameter that decreases in a direction from the proximal end to the distal end.

64. The rivet of claim 60, wherein the opening has a proximal end and a distal end and a diameter that increases in a direction from the proximal end to the distal end.

65. The rivet of claim 60, wherein the opening is defined by a wall within the head and one or more projections extend from the wall and into the opening for positively engaging the captured portion of the workpiece.

66. The rivet of claim 60, wherein the opening is defined by a wall within the head and a thread extends from the wall and into the opening for positively engaging the captured portion of the workpiece.

67. The rivet of claim 60, wherein a projection extends from an outer surface of the head of the mandrel away from the opening.

68. The rivet of claim 67, wherein the projection extending from an outer surface of the head of the mandrel is a helical thread.

69. The rivet of claim 59, wherein the shank has an external surface facing radially outwardly from the axial passage and the external surface includes an external projection for engaging the workpiece within the aperture thereof.

70. The rivet of claim 69, wherein the external projection on the external surface of the shank is a helical thread.

71. The rivet of claim 59, wherein the rivet body includes a cap at the first end of the shank that extends radially outwardly from the shank, the cap including a workpiece engaging surface that faces towards and is oriented at various angles to the shank.

72. The rivet of claim 59, wherein the mandrel includes an annular surface for initial contact with the workpiece that lies in a plane oriented transversely to the longitudinal axis of the mandrel.

73. The rivet of claim 59, wherein the mandrel includes an annular surface for initial contact with the workpiece that faces towards and is oriented at an acute angle to the longitudinal axis of the mandrel.

74. The rivet of claim 59, wherein the mandrel includes an annular surface for initial contact with the workpiece that faces from and is oriented at an obtuse angle to the longitudinal axis of the mandrel.

75. The rivet of claim 59, wherein the mandrel includes an annular surface for initial contact with the workpiece and teeth projecting from the annular surface.

76. The rivet of claim 59, wherein the mandrel includes first and second annular surfaces for initial contact with the workpiece, the first annular surface faces towards and is oriented at an acute angle to the longitudinal axis of the head and the second annular surface faces from and is oriented at an obtuse angle to the longitudinal axis of the head and the first and second annular surfaces meet at an apex.

77. At least two joined overlapping metallic workpieces that are joined together with a blind rivet:
the blind rivet including a mandrel and a rivet body;
the workpieces including an aperture that has been formed therethrough by contact between the mandrel and the workpieces, rotation of the mandrel about a longitudinal axis thereof at a speed to cause plasticization of the workpieces and penetration of the mandrel through the plasticized workpieces whereby the mandrel cores a portion of the plasticised workpieces and displaces the portion from the workpieces;
the rivet body including a shank having a first end, a second end and an axial passage extending through the shank between the first and second ends, the rivet body being positioned within the aperture and the mandrel being positioned within the axial passage whereby the shank is expanded radially outwardly and into engagement with the workpieces for joining the overlapping workpieces.

78. The at least two joined overlapping workpieces of claim 77, wherein the mandrel has captured the displaced portion of the overlapping workpieces.

79. The at least two joined overlapping workpieces of claim 77, wherein the mandrel includes an opening which is open in the direction of penetration of the mandrel through the overlapping workpieces and which accommodates the displaced portion of the overlapping workpieces.
